(19) United States
(12) Patent Application Publication
(10) Pub. No.: US 2025/0164817 A1
(43) Pub. Date: May 22, 2025

(54) Optical Display Device

(71) Applicant: InnerScene Limited, Gloucester (GB)

(72) Inventor: Jonathan Clark, Gloucester (GB)

(73) Assignee: InnerScene Limited, Gloucester (GB)

(21) Appl. No.: 18/955,617

(22) Filed: Nov. 21, 2024

(30) Foreign Application Priority Data
Nov. 21, 2023 (GB) 2317816.3
May 8, 2024 (GB) 2406459.4

(51) Int. Cl. G02B 30/26

(52) U.S. Cl. CPC G02B 30/26

(57) ABSTRACT

An optical display device arranged to generate in an output aperture a virtual a sky scene which is configured to make a user experience distant depth perception, the device comprising: an output light generation system for generating output light comprising a three-dimensional arrangement of a plurality of light control members, which are carried by one or more optically transparent substrates, and a light source arrange to project light to and/or from the light control members, and; an output aperture for output of the output light, wherein the light control members are configured for manipulation of the output light to create a distant object component with one or more features that appear to an observer gazing into the output aperture to be at an apparent depth ZA beyond a physical depth ZD of the device.

### TECHNICAL FIELD

The present disclosure relates to electrically operated optical display devices for creating an artificial sky light, wherein an observer experiences a perception of a sky scene when gazing into an output aperture of said device.

### BACKGROUND

U.S. Pat. No. 11,143,364B2 and US2018160504 disclose devices that are capably of creating an artificial sky component by means of a blue light guide panel. Such a device may lack the realism of an actual skylight.

Therefore, in spite of the effort already invested in the development of said devices further improvements are desirable.

### SUMMARY

### [General Device]

The present disclosure provides an optical display device arranged to create a perception of a virtual sky scene in output light and/or generate in an output aperture a virtual sky scene. In embodiments, the virtual a sky scene is configured to make a user experience distant depth perception, e.g. when gazing into the output aperture.

In embodiments, the optical display device comprises an output light generation system for generation of the output light. In embodiments, the optical display device comprises an output aperture for the output light. The sky scene (e.g. one or more of its components) may have the perception of distant/infinite depth as defined herein. In embodiments, the output light generation system comprises a light source to generate output light. In embodiments, the device comprises electrical circuitry to control the light source.

In embodiments, the output light generation system comprises a diffuse light generation system to generate a diffuse sky light component (which may be referred to as a clear sky component) in the output light. A diffuse light generation system may provide an appearance of a clear sky component in the sky scene. In embodiments, the diffuse light generation system includes redirecting members arranged to scatter incident light as the diffuse skylight component. In embodiments, the diffuse light generation system includes a waveguide with redirecting members to diffusively decouple light projected within the waveguide to the output aperture. In embodiments, a light source is optically coupled to the waveguide (e.g., at one or more side faces thereof).

In embodiments, the output light generation system comprises, a collimated light generation system arranged to generate a collimated sunlight component in the output light. A collimated light generation system may provide an appearance of a sun in the sky scene.

In embodiments, the output aperture comprises a transparent member. The output light is typically transmitted through the transparent member. In embodiments, the transparent member includes an interior face and an exterior face. The interior face may face the output light generation system and an exterior face may face away from the output light generation system, e.g., towards an observer gazing into said device. The output light is typically projected to the interior face, through the thickness of the transparent member, and from the exterior face. In embodiments, the output aperture comprises/is mounted to a frame. In embodiments, the frame extends around the output aperture, e.g., to define the output aperture.

### [Distant Object Generation]

In embodiments, the optical display device (e.g. the output light generation system) comprises light control members, and a light source (which may project light to the light control members and/or be the light control members, e.g. to project light from the light control members). The light control members are configured for manipulation of the output light to create a distant object component/a perception of a distant object in the sky scene (e.g. as a cloud component) with an optional diffuse sky light component (e.g. a blue sky) in the output light. The light control members may create either the distant object component or the diffuse sky light component. The diffuse sky light component may provide a stationary reference as a background to the distant object component (e.g. by appearing at a greater distant depth or infinite depth, including at least 1.5 or twice the depth which may be measured by the techniques disclosed herein, relative the or each feature of the distant object component).

As used herein the term “distant object component” may refer to one or more features that appear to an observer gazing into the output aperture of the optical display device. The features are not part of the diffuse sky light component and a collimated sunlight component (in embodiments where either of these are present). Said features can include a cloud component (e.g. a cloud) and/or a horizon component or other distant objects. As used herein the term “horizon component” may refer to a one or more features comprising a portion of land or sea that meets the sky. The or each feature may appear with a distant depth.

In embodiments, the distant object component comprises one or more features that appear to an observer gazing into the output aperture to be at an apparent depth ZA (e.g. to achieve said distant depth). In embodiments, ZA is beyond (e.g. greater than) a physical depth ZD of the optical display device. In embodiments, ZA is at least 5 or 10 or 20 times ZD. In embodiments, ZA is greater than 5 m or 10 m or 20 m.

As used herein, the term “ZD” or “physical depth of the optical display device” may refer to a depth of the optical display device in a direction orthogonal to a plane of the output aperture. It may refer to a total dimension of the device in said direction. The depth may include all associated components of the device that form its depth, e.g. the output aperture, a housing and the components of an output light generation system. In embodiments, a total depth of the device is a minimum of 2 cm or 3 cm or 4 cm. In embodiments, a total depth of the device is a maximum of 7 cm or 10 cm or 20 cm or 30 cm or 40 cm. Any of the aforesaid maximums and minimums may be combined in a range.

As used herein, the term “ZA” may refer to a virtual location of the or each feature that is generated by the optical display device. ZA may comprise a perpendicular distance in the depth direction from the output aperture to a perceived depth of the or each feature. ZA may optionally also include a perpendicular distance in the counter depth direction from the output aperture to a line connecting the viewing positions.

In embodiments, and ZD and ZA are determined by projecting line of sight vectors V1, V2 from first and second viewing positions P1, P2 through the output aperture to a perceived location of the one or more features, such that ZA represents a perpendicular distance from the output aperture (e.g. its exterior face or centreline) to a convergence point (e.g. a focal point) of these vectors beyond (e.g. virtually beyond and behind) the physical depth ZD of the device.

As used herein, the term “line of sight vectors” may refer to an unbroken, direct line that extends from a viewing position to the or each feature to, so that light may be received from the or each feature, e.g. without reflection from an intermediate member.

As used herein, the term “viewing position” may refer to a point of reference which is spatially separated from another viewing position (e.g. in the case of first and second viewing positions).

Said spatial separation may refer to a different lateral and/or longitudinal position at the same depth with respect to the output aperture. A first and second viewing position may refer to separate eyes of an observer or camera positions, or separate positions the observer. Typically, the viewing positions are 0.5-4 meters in a perpendicular direction from the output aperture of the device.

As used herein, the term “perceived location” may refer to a virtual location of the or each feature that is generated by the optical display device based on the line of sight vectors.

By implementing a plurality of light control members to create a perception of a distant object component in the sky scene (e.g., in addition to a clear sky component, which may be blue or blue/grey), a realism of the device may be improved. Particularly, if the distant object component has one or more features which appear with a distant depth as defined herein. The light control members may manipulate light projected to thereto and/or may modify the output light itself by means of emitting a one or more wavebands/wavelengths (e.g. colours) of light. The distant object component may present as diffuse light.

In embodiments, ZA is measured by gaze vectors from eyes (e.g. with one eye at the first viewing position and another eye at the second viewing position) of an observer gazing into the output aperture converging on one of more of said features. A user may be subject to normal vision.

In embodiments, ZA is measured by vectors of a first camera and spatially separated second camera (e.g. with one camera at the first viewing position and another camera at the second viewing position) projecting into the output aperture converging on one of more of said features.

In embodiments, a depth of the one or more features of the distant object component is characterised by a parallax shift (e.g. a displacement in apparent position) corresponding to the apparent depth ZA when observed from laterally displaced positions (e.g. the first and second viewing positions which may have the same depth measured from the output aperture but different line of slight vectors).

In embodiments, the optical display device is configured for mounting to a wall or a ceiling as a virtual skylight or virtual window. For example, it may have a mounting assembly suitable for mounting as a permanent fixture to said celling or wall. In embodiments, the output aperture has a side length (e.g. a shortest dimension of a rectangular shaped output aperture) or diameter (e.g. for a circular shaped output aperture) of greater than 25 or 30 or 40 cm. In embodiments, an eye box, over which an entire view of the sky scene can be observed (e.g. each of the or each features of the distant object component are visible), extends over the entire output aperture.

In embodiments, the light control members are arranged to create the or each feature of the distance object component with Morie interference patterns. Such an arrangement may provide convenient formation of the or each feature of the distant object component, e.g. by having light control members that are spatially separated in the depth direction.

In embodiments, the output light generation system generates a background diffuse sky light component. In embodiments the diffuse sky light component is uniform to the extent where the intensity and/or colour does not vary by more than 10% or 20% or 30% or 40% for any given circular area on the output aperture of 10 mm diameter over at least 90% of the output aperture. Said uniform may be measured absent the distant object component (e.g. with the light control members removed from the device) and/or in areas of the sky scene/output aperture which do not comprise the distant object component. Such a uniformity may provide a perception of distant or infinite depth of the diffuse sky light component.

In embodiments, the distant object component comprises a cloud component with the or each features arranged as clouds. In embodiments, the clouds presents as one or more of: 1) a colour which is one or more of: white; grey (including dark and/or light grey, where for a 0 white to 100 black standard grey scale colour value, grey is 1-70 and light grey is 1-50 and dark grey is 51-99, grey may also be defined as white light at lower intensities); orange; yellow; red; purple, the latter being for sunset/sunrise) 2) nebulous patterns 3) non-uniform regions, comprising: rolling formations; layered formations; puffy formations; wispy formations 3) a space between the clouds comprising the diffuse sky light component (e.g. as the sky surrounding the clouds, which may be blue).

In embodiments, the distant object component comprises a horizon component with the or each feature composing of sea or land. In embodiments, the sea or land presents as one or more of: 1) a colour which is one or more of: green; blue (including dark blue relative the diffuse skylight component; orange; yellow 2) a uniformity which is one or more of: comprising uniform regions; comprising non-uniform regions 3) at a lower region of an output aperture (for a device arranged in a side-wall of a building, including as a window) with a diffuse skylight component and optional cloud component at an upper region 4) mountains.

In embodiments, other features of the distant object component include one or more of: a flying objects (birds, planes etc.); plant material (e.g. trees, leaves, etc.); buildings and other human made objects. Such features may be implemented by controlling an emission of the light control members or a light source projecting to said members.

In embodiments, the light control members have a three-dimensional arrangement. In embodiments, the light control members are arranged over a plurality of layers. In embodiments, the light control members are carried by at least one optically transparent substrate.

By implementing an optically transparent substrate to carry the light control members, output light may be projected through the optically transparent substrate to interact with the light control members or from the light control members (e.g., and through optically transparent substrate) to the output aperture. Hence supposition of the effect of multiple light control members with difference spatial arrangements maybe conveniently implemented with the optically transparent substrate.

As used herein the term “light control members” may refer to an arrangement of members which are configured to pass, absorb or emit specific bands of the visible spectrum. Hence, in a passive configuration, the light control members can be arranged as absorbers, and in a in an active configuration, the light control members can be arranged as emitter e.g., as LEDs, including OLEDs.

As used herein the term “manipulation of output light” may refer to the control of the output light to create the perception of the or each feature of the distant object component. The output light may be controlled by emission or absorption.

As used herein the term “perception of a distant object” may refer to a user with normal vision at a normal viewing distance (e.g., 0.5-4 meters) from the device, perceiving a presence of one or more distant objects (e.g., a cloud) in the artificial sky scene when gazing into he output aperture of the device. The distant object component may be present along with a clear sky component (which may be blue) of a sky light component. The distant object component may be present along with a sunlight component.

As used herein the term “three-dimensional arrangement” in respect of the light control members may refer to a spatially separated arrangement that extends in three directions, including a longitudinal, lateral and depth direction. A three-dimensional arrangement may preclude the light control members all being arranged on the same plane since this would only be a two-dimensional arrangement. A three-dimensional arrangement of the light control members may enable the perception of the distant object with a depth component. A three-dimensional arrangement of the light control members may therefore comprise an arrangement of the light control members over a plurality of layers that each extend in a plane defined by the longitudinal and lateral directions, which are spatially separated in the depth direction. Such an arrangement may be achieved by a one or a plurality of planar optically transparent substrates, which have the light control members arranged on one or both faces, and which are arranged adjacent each other as a stack/laminate in the depth direction. A three-dimensional arrangement of the light control members may therefore comprise an arrangement of the light control members which are distributed in an optically transparent carrier medium. Such an arrangement may be achieved by 3-d printing of the optically transparent carrier medium and the light control members.

As used herein the term “layers” in respect of the light control members may refer to an arrangement of the light control members on a plane defined by the longitudinal and lateral directions, on which the light control members all have the same depth.

A point of reference for position/pitch of the light control members may be a centroid or other suitable common reference point.

As used herein the term “optically transparent substrate” may refer to a medium which is transparent to visible wave bands. Examples include glass or plastic based including acrylic. The optically transparent substrate may be planer.

In embodiments, the or each optically transparent substrate comprises at least one layer of light control members. By arranging the light control members over multiple layers on one or both faces of one or multiple optically transparent substrates, enhanced depth perception of the distant object may be provided. Particularly, by having the layers with regular depth spacing, numerical calculation of the position of the light control members may be simplified.

In embodiments, a plurality of optically transparent substrates are arranged adjacent each other as a stack. The stack may comprise the optically transparent substrates adjoining each other or in close proximity but not in contact, e.g., with an airgap.

In embodiments, the or each optically transparent substrate is arranged parallel and to extend over the output aperture. By arranging the optically transparent substrate to overlap the output aperture (e.g., when viewed in the counter depth direction), convenient manipulation of the output light to include the distant object component may be conveyed to the output aperture.

In embodiments, the output light generation system comprises the light source arranged to project light to the light control members. With such an arrangement the light control members may manipulate the projected light to create the distant object component.

In embodiments, the light source comprises a transparent light panel, which is downstream of the light control members, and projects light to the light control members in an upstream direction for interaction with the light control members and subsequent downstream projection. Downstream may be defined as the direction the output light takes to the output aperture, which is generally in a counter depth direction. With such an arrangement the transparent light panel projects light to the light control members, which is projected back through the transparent light panel in the depth direction. The panel may be implemented as a waveguide with redirecting/decoupling features or as an arrangement of sources.

As used herein the term “redirecting/decoupling formations” may refer to features that decuple light internally reflected from within a waveguide.

In embodiments, the light source comprises an arrangement of sources that are positioned in alignment with the light control members. For example, an array of point sources may efficiently each couple to a dedicated light control member.

In embodiments, the light source comprises a side lit arrangement in which light is projected parallel to a plane of and into the optically transparent substrate(s). By implementing an edge lit transparent substrate, efficient coupling of the light to the light control members may be achieved.

In embodiment, the light source is arranged as a panel, which is upstream of the light control members, and projects light to the light control members in a downstream direction. The panel may be implemented as a waveguide with redirecting/decoupling features or as an arrangement of sources.

In embodiments, the light projected to the light control members is collimated, e.g. directional, which may be relative the diffuse skylight component. Collimated light may have a greater coupling efficiency and may enable less light control members in the depth direction to create a particular effect.

In embodiments, the light projected to the light control members is diffuse.

In embodiments, the light control members are arranged to control either the distant object component or the diffuse sky light component.

In embodiments, the output light generation system comprises a (background) colour emission system arranged to emit a colour of the distant object component (e.g. the cloud component) or the diffuse sky light component. The colour emission system may emit a background colour, e.g.

a diffuse sky light component, that surrounds the emission from the light control members, e.g. clouds, or the converse. The colour emission system may be independently controllable of the other components of the sky scene, e.g. by electrical circuitry of the system. The colour emission system may emit diffuse light having a different colour to the light source.

In embodiments, the colour emission system is arranged as a panel upstream of the light control members. The colour emission system may be implemented as a waveguide with redirecting formations arranged to redirect light from the wave guide as the diffuse skylight component and/or a diffuse light reflector panel. With such an arrangement the colour emission system may project though (e.g. via transparency) the aforedescribed light source examples that project light to the light control members.

In embodiments, the light control members are arranged aligned in a depth direction to each other. For example, between the plurality of layers of the light control members, the light control members overlap each other when viewed in a longitudinal and lateral plane. A centroid of the light control members may be aligned to a common axis aligned in the depth direction. In embodiments, between the layers, the light control members may be arranged with a same pitch, e.g. a distance between the centroid in the longitudinal and/or lateral direction. A depth distance between the layers may be the same (including substantially the same) as the pitch in the longitudinal and/or lateral direction. In embodiments, the light control members are arranged to have the same size (e.g. including substantially the same size, in one or more of a depth, longitudinal, or lateral dimension). Such an arrangements may permit creation of the distant object component with the Moiré effect.

In embodiments, the light control members are transparent to one or more visible wavebands of incident light (e.g. they comprise a pigment to impart a colour change in the light) and may be arranged as domes, e.g. to have a lens effect to distribute the incident light to a flat face of the dome arranged on the substrate.

In embodiments, the light control members are reflective and/or to refract, to one or more visible wavebands of incident light (e.g. they comprise a pigment to impart a colour change in the light), including diffusely reflective. In embodiments, the light control members have varying one or more of: opacity, transparency, or reflectivity.

In embodiments, the light control members are arranged to provide a perception of a distant object component of the sky scene positioned at an infinite distance away from an observer gazing into the output aperture. Such an arrangement may improve realism of the device.

In embodiments, the light control members are arranged to provide a perception of a diffuse sky light (e.g. as one or more of blue, white, grey coloured) component positioned at an infinite/distant distance away from a observer gazing into the output aperture, which may surround the or each feature of the distant object component. Such an arrangement may be achieved by a having a clear sky component that presents as uniform (e.g., in intensity and/or colour to a user). Such an arrangement may improve realism of the device.

In embodiments, the light control members are arranged to provide a perception of distant objects arranged with a depth. Such an arrangement may be achieved by a having the light control members spatially separated in the depth direction. Such an arrangement may improve realism of the device.

In embodiments, the light control members are arranged/configured to provide a perception of the one of more features of the distant objected component having said apparent depth ZA and maintaining a fixed apparent depth ZA position as the observer move beneath/over the output aperture (e.g. across the output aperture). Such an arrangement that implements motion parallax may improve realism of the device.

In embodiments, the light control members are arranged to provide a perception of distant objects (e.g. clouds) moving through the sky scene. Such an arrangement may be implemented with light control members arranged to emit light in a sequence to convey motion. Such an arrangement may improve realism of the device since the cloud component moves naturally through the sky.

In embodiments, the diffuse light generation system is arranged to generate a diffuse sky light component that presents as a clear sky component in the sky scene. The clear sky component may surround the cloud component. In embodiments, the clear sky component is blue, although other colours may be implemented, e.g., grey, reds (e.g., to represent sunset or sunrise).

In embodiments, the diffuse sky light component is projected to the light control members for manipulation of the light.

In embodiments, the diffuse light generation system includes the light control members arranged to emit the diffuse sky light component. By implementing the light control members to emit the clear sky component and/or the distant object component convenient control of the sky scene may be provided.

In embodiments where a collimated light generation system is arranged to generate collimated light that presents as a sunlight component in the sky scene, the sunlight component may be projected through the or each optically transparent substrate. Such an arrangement may provide convenient integration of sunlight and distant object creation.

In embodiments, the optical display device comprises a light source arranged to project light in a depth direction through the optically transparent substrate to the output aperture. By implementing a light source (e.g., as a panel which may extend entirely over the optically transparent substrate) to backlight the optically transparent substrate convenient integration of components may be provided.

In embodiments, the or each optically transparent substrate extends in a longitudinal and laterally extending plane, said device comprising a light source arranged to project light parallel to said plane to the light control members. By implementing a side lit optically transparent substrate arrangement convenient transmission of light to the light control members may be implemented.

In embodiments, the light control members are configured as deposited formations, for example a printed or other deposition technique. Such an arrangement may be cost effective.

In embodiments, the light control members are configured as surface/decoupling formations of the or each optically transparent substrate, for example an etching, embossing, debossing or other technique. Such an arrangement may be cost effective.

In embodiments, the light control members are configured as light emitting units, for example as LEDs, including OLEDs, or as pixels or other suitable configuration. Such an arrangement may enable adaptation of the cloud component, e.g., in terms of size, shape colour etc.

In embodiments, the light control members are configured for light manipulation by absorption of one or more visible wavebands of incident light. For example, as a wave band stop.

In embodiments, the light control members are configured for light manipulation by transparency to one or more visible wavebands of incident light. For example, as a wave band pass.

In embodiments, the light control members are configured for emission of one or more visible wavebands of the output light. For example, as a wave band emission. In embodiments, a band emission and/or intensity off the light control members is controllable. In embodiments, the band emission and/or intensity is controlled by layer and/or a group of a plurality of light control members (e.g., those that emit the same colour). For example, control of groups/layers may be achieved by: LED groups forming the light control members or projecting light to the light control members being independently controllable; light sources of edge lit transparent substrates being independently controllable, with said transparent substrates comprising the light control members. Electrical circuitry of the system may implement said control.

In embodiments, the light control members have a length scale of 10 μm-1 mm. Such a range has been found to suitably define distant objects, e.g. clouds.

As used herein the term “length scale” may refer to a characterising length of a light control member in a plane defined by the longitudinal and lateral directions. For example, for a circular light control member a length scale may be the diameter, for a rectangular light control member a length scale may be a length of the major longitudinal edge.

In embodiments, the layers (e.g., a thickness of the optically transparent substrate) are separated by a depth distance of 0.1 mm-5 mm or 0.1 mm-10 mm (which may also be a thickness of the optically transparent substrate). Such a distance has been found to provide suitable depth perception of the distant objects, e.g. the clouds.

In embodiments, there are 2-10 or 2-20 or 2-50 layers of light control members. Such an arrangement has been found to provide suitable depth perception of the distant objects, e.g. the clouds.

In embodiments, the light source is adaptive (e.g. by control of the light projected to/from the light control members individually or as groups/layers) to implement adaptation of the or each feature of the distant object component in terms of one or more of: intensity; colour; depth perception; position.

In embodiments, the optical display device of any preceding is configured to implement in respect of a cloud component one or more of adaptive: cloud distance from observer perception (e.g., by controlling an emission of the light control members); cloud size (e.g., by controlling an emission of the light control members); cloud colour (e.g., by controlling an emission band or intensity of the light control members or a light source projecting to the light control members); cloud intensity (e.g., by controlling an emission of the light control members a light source projecting to the light control members), and; cloud motion (e.g., by controlling an emission of the light control members). The equivalent may also be implemented for other examples of the distant objects.

In embodiments, the optical display device is configured to provide a perception of a clear sky component, which is adaptive in terms of one or more of: intensity (e.g., by controlling an intensity of a light source), and; colour (e.g., by controlling an intensity and/or band emission of a light source).

In embodiments, the clear sky component and/or distant object component is adaptive based on real time information, so that said adaptation is representative of the associated change in the real-life sky.

As used herein the term “real time information” may refer to one or more of: information based on weather conditions (e.g., wind speed, satellite data of cloud position, size, density etc.); information based on time of day, and; information based on images of a real-life sky.

In embodiments, any of the aforedescribed adaptivity may be user controlled, (e.g., as an alternative to being based on real time information).

In embodiments, the light control members have distinct arrangements over each layer. By arranging the light control members to have different patterns over the layers, an appearance of realistic distant objects, e.g. clouds, may be recreated.

In embodiments, the light control members are arranged/operated on the layers based on an algorithm/computer program, which includes as an input a desired image of one or more distant objects to be created in the sky scene and as an output for the light control members one or more of: an arrangement; an emission, and; an absorption.

The present disclosure provides a system comprising the optical display device and one or more processors/electrical circuitry implementing an algorithm/computer program, which has as an input a desired target image of one or more features of a distant object component (e.g. clouds) to be created in the sky scene and as an output an arrangement of the light control members, which may include one or more of: an arrangement (e.g. in terms of one or more of size, position, spacing, number per layer); an emission (e.g. an opacity or reflectivity), and; an absorption.

The algorithm may implement one or more of: Nonnegative Matrix Factorization NMF; Fourier Domain Analysis, and; other computational technique to determine a position and/or emission/absorption band of the light control members.

In embodiments, an algorithm is configured to extract the one or more features of the distant object component from a target image of a real-life sky. An example of a suitable feature extraction algorithm is ORB (Oriented Fast and Rotated Brief).

The processors may be implemented as part of the device or distributed in the system. In embodiments. The electrical circuitry may be implemented as one or more processors. The processors may execute program code stored on electronic memory and/or may execute programmable logic, e.g., as a logic array, gate array, structured array etc.

The present disclosure provides a computer program for determining an arrangement of the light control members of the device of any preceding embodiment or another embodiment disclosed herein. The computer program may be implemented by electrical circuitry as defined herein, including executable by one or more processors and optional electronic memory. In embodiments the computer program including: as an input a target image of one or more features of a distant object component to be created in the sky scene, and; as an output an arrangement of the of the light control members, which may include one or more of: a spatial arrangement; an emission, and; an absorption, to achieve a sky scene comprising the or each feature of the target image.

As used herein the term “target image” may refer to an image of a real-life sky for recreation by the device. It may also refer to an image comprising the or each feature of the distant object component, e.g. extracted from the image of a real-life sky.

In embodiments, the arrangement of the light control members determined based on an appearance (e.g. a numerically simulated appearance) of the or each feature in the sky scene being the same (including substantially the same) at a plurality of spatially separated viewing positions (e.g. positions at different lateral and/or longitudinal positions with respect to the output aperture.

### [Use]

The present disclosure provides use of the device of any preceding embodiment, or another embodiment disclosed herein for creating a perception of one or more feature with a distant depth, e.g. clouds, in a sky scene.

### [Method of Assembly]

The present disclosure provides a method of assembling an optical display device, which may be arranged to create a perception of a sky scene (e.g., in output light) and/or to generate in an output aperture a virtual a sky scene which is configured to make a user experience distant depth perception. The method may implement the features of any preceding embodiment, or another embodiment disclosed herein.

In embodiments, the method comprises, arranging a three-dimensional arrangement of a plurality of light control members, which are carried by one or more optically transparent substrates. In embodiments, the method comprises arranging a light source arrange to project light to and/or from the light control members.

In embodiments, the method comprises determining an arrangement of light control members based on a target image comprising one of more features of the distant object component, the method comprising extracting the one or more features of the distant object component from the target image of a real-life sky. In embodiments, the method comprises forming the light control members on or as part of the optically transparent substrate with a printer.

In embodiments, the method comprises arranging, three-dimensionally, light control members carried by one or more optically transparent substrates. In embodiments, the light control members are configured for manipulation of output light to create a perception of distant objects, e.g. clouds, in the sky scene. In embodiments, the light control members are configured for manipulation of output light to create a distant object component with a perception of objects and a diffuse sky light component in the output light.

In embodiments, the method comprises determining an arrangement of light control members based on numerical simulation of a target image of distant objects. Computation methods may provide a suitable means for determining the position of the light control members, e.g. for complex cloud formations.

In embodiments, the method comprises arranging a plurality of optically transparent substrates together as a block. By arranging the optically transparent substrates into a block (e.g., with the optically transparent substrates connected) a desired arrangement of the light control members relative to each other may be fixed within the block, which may simplify subsequent assembly of the bock as part of the device.

In embodiments, the optically transparent substrates are connected together by one or more of the following techniques: an adhesive connection; a bonded connection; lamination; resin casting; fusion bonding; solvent bonding. The connection may be configured to maintain position of the light control members for a range of operative temperatures e.g. 10-50 degrees C.

In embodiments, the method comprises forming the light control members on or as part of the optically transparent substrate with a printer. Printing the light control members on or as part of a 3-d printing arrangement, may enable cost effective and precise location of the light control members.

### [Method of Generating Sky Scene]

The present disclosure provides a method of creating a perception of a sky scene comprising distant objects such as clouds (e.g. in output light) and/or generating in an output aperture a virtual a sky scene which may be configured to make a user experience distant depth perception. The method may comprise creating said impression through a perception of an aperture in a building.

The method may implement the features of any preceding embodiment, or another embodiment disclosed herein.

In embodiments, the method comprises projecting light to/from a three-dimensional arrangement of a plurality of light control members, which are carried by one or more optically transparent substrates.

In embodiments, the method comprises manipulating the output light with the light control members to create a distant object component comprising one or more features that appear to an observer gazing into the output aperture. The or each features may have a distant depth as defined herein.

In embodiments, the method comprises projecting output light to interact with and/or from a plurality of three-dimensionally arranged light control members, carried by one or more optically transparent substrates, to an output aperture. In embodiments, the method comprises; manipulating the output light with the light control members to create a perception of the distant objects in the sky scene.

In embodiments, the method comprises manipulating the output light with the light control members to create a distant object component with a perception of objects and a diffuse sky light component in the output light.

In embodiments, the method comprises projecting the output light through a transparent member of an output aperture.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIG. 1 is a block system diagram showing an embodiment system for creating an artificial sky scene.

FIGS. 2 and 3 are block system diagrams showing embodiment optical display devices for creating an artificial sky scene of the system of FIG. 1.

FIG. 4 is an illustrative diagram showing the embodiment optical display device of FIG. 3.

FIG. 5 is a block system diagram showing an embodiment optical display device for creating an artificial sky scene of the system of FIG. 1.

FIG. 6 is an illustrative diagram showing the embodiment optical display device of FIG. 5.

FIG. 7 is an illustrative diagram showing an embodiment distant object generation system for the optical display device of FIGS. 4 and 6.

FIGS. 8 and 9 are illustrative diagrams showing an embodiment optical display device comprising a distant object generation system of FIG. 7.

FIG. 10 is an illustrative diagram showing an embodiment distant object generation system for the optical display device of FIGS. 4 and 6.

FIG. 11 is an illustrative diagram showing an embodiment arrangement for measuring a distant depth of feature of an optical display device.

### DETAILED DESCRIPTION OF EMBODIMENTS

Before describing several embodiments of the device, it is to be understood that the device is not limited to the details of construction or process steps set forth in the following description. It will be apparent to those skilled in the art having the benefit of the present disclosure that the device is capable of other embodiments and of being practiced or being carried out in various ways.

The present disclosure may be better understood in view of the following explanations:

As used herein the term “optical display device” or “device” may refer to electrically operated optical apparatus that is capable of providing an observer with a perception of a real-life sky when gazing into an output aperture of the device. The device creates a virtual sky scene. The virtual sky scene may have a perception of infinite depth (as for a real-life sky). The device may be dimensioned such that it is suitable for attachment to a ceiling or wall (e.g. a side wall, including a window) of an interior or a building, e.g., it is less than 1.5 meters or 2 meters or 3 meters in lateral and/or longitudinal dimension; it may be greater than 0.20 meters in lateral and/or longitudinal dimension; it may have a depth of less than 0.5 meters. The output aperture may extend over a substantial amount of the lateral and/or longitudinal dimension of the device, e.g. within a frame that frames the output aperture that has a peripheral width of 0.5-5 cm in said lateral and/or longitudinal dimension. The device may be configured to be powered by a mains electrical supply, e.g. 110-120 v or 220-240 v ac.

The device may recreate characteristics of said real-life sky. As used herein, the term “characteristics of a real-life sky” may refer to any optical characteristic of the real-life sky that is capable of measurement and replication in output light from the optical display device. A characteristic may include one or more of the following: a real-life colour of a real-life sky light component; a real-life colour of a real-life sun light component; a real-life intensity of a real-life sky light component; a real life intensity of a real life sun light component; an angle of the real life sun light component; a real-life colour of a real-life cloud component; a real-life intensity of a real-life cloud component, and; a real-life/representative spatial distribution of a real-life cloud component.

As used herein, the term “intensity” may refer to any quantity related to a brightness perceived by a user, e.g., one or more of a: radiant intensity, measured in watts per steradian (W/sr); luminous intensity, a measured in lumens per steradian (lm/sr), or candela (cd); Irradiance; luminous power, or luminous flux) measured in lumen. As used herein, the term “colour” may refer to a colour measured by a suitable colour system which may enable digital representation, e.g., colour correlated temperature (CCT) or a colour space, including RGB, sRGB, a Pantone collection, CIELAB or CIEXYZ etc. As used herein, the term “real-life colour” may refer to a colour as measured by a colour system, which is assigned, e.g., as an average or other numerical approximation, to an object. The object can be the sun or the sky or the clouds. Said colour of the object may be measured without interference (including substantial interference) from other objects in the sky scene.

As used herein the term “real-life sky” may refer to a sky view that an observer observes when gazing through a window (e.g., in a side wall or ceiling) of a structure or otherwise from the ground. The portion of the sky view observed typically comprises the sun and surrounding sky and clouds, but in some cases, it may only comprise only the sky and/or clouds. Hence a real-life sky may include a real-life sky light component and/or may include a real-life sun light component and/or may include a real-life cloud component. The real-life sun light component may include a circular (including substantially circular) yellow/white sun (e.g., a warm colour) and includes direct light. The real-life sky light component includes indirect light from the sun and is absent the real-life sun light component and the real-lift cloud component. The real-life sky light component may include a clear sky component, e.g., a blue/cold colour. The real-life sky light component may surround (including partially or fully) the circular sun and/or the real-life cloud component. The real-life cloud component can surround and extend over (including partially or fully) the sun.

As used herein “warm” in respect of the sun light component may refer to a yellow and/or white colour. The CCT may be 3000-5000 k. As used herein “cold” in respect of the sky light component may refer to a blue and/or white colour. The CCT may be 5000-10000K.

As used herein the term “perception of infinite depth” may refer to a depth of an object (e.g., the sky and/or sun and/or cloud) in three dimensions being perceived as infinitely far away from an observer with stereopsis (e.g., binocular vision). A perception of infinite depth may be provided by one or more of: binocular convergence; motion parallax, and; accommodation visual depth perception cues, e.g., no conflict exists between these visual perception cues. The condition of infinite depth may be determined based on gaze vectors of the eyes of an observer with normal vision having the same and/or a similar alignment when looking into the device as for looking at the sky and/or sun in the real-life sky. The condition of infinite depth based on motion parallax may be determined based on the image of the sun appearing to be projected from the same location, e.g., moving, as an observer moves laterally and/or longitudinally across the output aperture. An observer user may maintain the same gaze vector associated with infinite depth during said motion.

As used herein the term “distant depth” may refer to a condition of infinite depth or other substantially far field depth, e.g. at least 5 or 10 or 20 or 50 or 100 metres in a depth direction from the output aperture. It may be defined by gaze vectors of an observer gazing (e.g. from both their eyes, with normal vision) into the output aperture converging to a depth distance beyond the device, e.g. to one of said distance ranges discussed above.

As used herein the term “sky scene” or “virtual sky scene” may refer to a scene comprising a virtual representation that an observer observes when gazing through the output aperture of the optical display device. A sky scene may include a virtual sky light component and/or may include a virtual sun light component and/or may include a distant object (e.g. a cloud and/or horizon) component. The sky scene may include a circular (including substantially circular) sun coloured image of the sun light component. The sun may be surrounded (including partially or fully) and/or overlapped (including partially or fully) by the sky light component and/or cloud component. The cloud component may be surrounded (including partially or fully) and/or overlapped (including partially or fully) by the sky light component.

As used herein the term “perception of a sky scene” may refer an observer perceiving a sky scene as being present in the real world, based on the construction by the device of a virtual sky scene that is sufficiently representative, e.g., in terms of chromatic and spatial distribution of light, to present as in the real-life sky.

As used herein the term “artificial sky light component” or “diffuse light component” may refer to artificial light that is representative of the real-life sky light component (e.g., absent the real-life sun light component and real-life cloud component), which can include a clear sky component during daylight, sunset or sunrise. It may be representative of the real-life sky light component in respect of one or more of: colour, e.g., as defined by a CCT (e.g., 5000-10000K), the colour may only be blue or optionally white, e.g. to exclude sunrise/sunset conditions; diffusivity; luminance profile or intensity; other suitable parameter, and; a variance of any of the aforesaid over an output aperture of the device. The diffuse light component may be uniform such that is does not vary by more than 10% or 20% or 30% or 40% over the entire output aperture, e.g., in terms of one or more of: colour; luminance (e.g. in candelas per square meter (cd/m²), including luminance profile); intensity, and other suitable parameter. More particularly, said one or more parameters may be uniform to the extent where they do not vary by more than 10% or 20% or 30% or 40% for any given circular area on the output aperture of 10 mm diameter over at least 90% of the output aperture. In a particular example, the diffuse light is propagated over a HWHM solid angle that is at least 4 times larger or 9 times larger or 16 times larger than for the subtending HWHM solid angle of the sun light measured in Sr. The artificial sky light component may have a lumen of 3000-10.000, or 4000-7000. The diffuse sky light component in the output light may have a Lambertian distribution. A Lambertian distribution may refer to a type of diffuse reflection or scattering of light from a surface. The Lambertian model assumes that a surface reflects light uniformly in all directions. This means that the intensity of the reflected light is proportional to the cosine of the angle between the incoming light direction and the surface normal.

As used herein the term “artificial cloud component” or “cloud component” may refer to artificial light that is representative of the real-life cloud component (e.g., absent the real-life sun light component and real-life sky component). The cloud component may refer to one or more formations of objects that present an appearance of clouds. It may be representative of the real-life cloud component in respect of one or more of: colour, e.g., as defined by a CCT (e.g., 4000-6500K); diffusivity; luminance profile or intensity; non-uniformity other suitable parameter, and; a variance of any of the aforesaid over an output aperture of the device.

As used herein the term “sun light component” or “direct light component” may refer to artificial light that is representative of the real-life sun light component. It may be representative of the real-life sun light component in respect of one or more of: colour, e.g. as defined by a CCT (e.g. 3000-5000 k, which is less than that of the sky light component); divergence (e.g. an angle of divergence of the light rays may be no more than 5 or 2 or 1 or 0.5 degrees relative each other); luminance profile or intensity; other suitable parameter, and; a variance of any of the aforesaid over an output aperture of the device. In a particular example, the luminance profile of the sun light may have a narrow peak in the angular distribution around the direction of propagation which is subtended by a HWHM solid angle smaller than 0.2 sr or 0.3 sr. The sun light component may be projected uniformly over the output aperture, e.g., such that an average direction of propagation within a circle of diameter 10 mm at any position over the output aperture does not vary in angle by more than 2 or 5 or 10%. The sun light component may present to a user when looking into the device, as a circular disc positioned at infinity. As used herein the term “collimated light” may refer to light that has been processed by a collimated light generation system, which may form the sun light component.

As used herein the term “output aperture” may refer to a viewing window of the device into which an observer can gaze. The output aperture may be 0.3-2 m×0.3-2 m. The output aperture outputs the output light which is generated by the device. The output aperture may include a transparent member or a void instead of such a member. The output aperture may include a frame that frames the transparent member. As used herein the term “transparent member” may refer to a medium through which the output light is projected. The transparent member may be planar. The transparent member may be formed of glass or plastic or other suitable material.

As used herein the term “reflective member” may refer to an object that is capable of reflecting an image by specular reflection. It can include a member with any surface in which the texture or roughness of the surface is smaller (smoother) than the wavelength of the incident light. It may include surfaces formed of one or more of the following reflective materials: metals; metal oxides, and; dielectric materials. Examples of which include silver, aluminium, a titanium oxide based material including titanium dioxide or titanium trioxide. Any of the aforementioned may be applied as a thin coating on a glass carrier.

As used herein the term “a reflective and partially transmissive member” or “partially reflective member” may refer to a reflective member as defined above, which is additionally configured to transmit therethrough a portion of light which is not reflected. An example of which is a member formed with a lesser thickness than for the aforedescribed reflective material. The transmissivity maybe less than 50% or 30% for incident electromagnetic radiation. The thickness of the reflective material may be any one or the following: less than 700 nm; less than 100 nm; less than 50 nm, and; less than 5 nm, with any of the aforementioned maximum thickness ranges implemented with a minimum thickness of 1 nm.

As used herein the term “output light generation system” may refer to a single (or a distributed system) capable of generating the output light. The output light generation system maybe implemented as a diffuse light generation system and/or a collimated light generation system. The output light generation system may generate all the output light, or part of the output light. For example, output light may also include a portion of light down stream of the output aperture (e.g. other lighting in a room where said device is installed) which is transmitted into the device, via the output aperture, reflected and projected back out.

As used herein the term “diffuse light generator” or “diffuse light generation system” may refer to a single or a distributed system capable of generating the diffuse light component, e.g., light which is scattered at many angles as opposed to one angle as with specular reflection/collimated light. The diffuse light generator may generate the diffuse light component by redirecting/scattering light that is incident/encounters uncoupling/redirecting features. The light may be supplied by a dedicated light source. The diffuse light generator may be at least partially transparent and may at least partially generate the diffuse light component from the light transmitted therethrough (which can include light from the collimated light generation system). The uncoupling features/redirecting features may be implemented as one or more of the following: particles to scatter light; conical micro cones; micro lenses; quantum dots; surface features, including surface etching, and; other suitable implementations. As used herein the term “scattering light” may refer to a process performed on light by the diffuse light generator to generate diffuse light, any may include Rayleigh scattering. As used herein the term “particles to scatter light” may refer to particles with a diameter selected to scatter some or all wavelengths of visible light. The diameter of the particles may be micro or nano (e.g., to operate in the Rayleigh regime). The diffuse light generator can include said particles arranged in a medium, e.g., as a waveguide. Examples include titanium dioxide suspended in PMMA. As used herein the term “light guide panel” or “waveguide” may refer to a generally planar member, which is arranged to convey light in an in-plane direction, e.g., by total internal reflection. The waveguide may be edge lit or otherwise lit by a light source. The waveguide may be implemented as the diffuse light generator, e.g., with a diffuse light component to exit the waveguide upon encountering an uncoupling/redirecting feature.

As used herein the term “light source” may refer to any arrangement capable of generating artificial light. It can include arrangements that transform electrical current into a light emission, e.g. as luminous radiation. The light may have wavelengths in the range of 400-700 nm. The light source can include one or more of the following: a white light source, or perceived as such by the eye, e.g., an incandescent lamp, a fluorescent lamp, a mercury vapor discharge lamp; an LED or a white light laser diode (that is, such that the primary source is combined with a phosphor or several phosphors) or a combination of LEDs or laser diodes of different colour, and; other suitable light source. The light source may include a light guide panel to receive light from an emitting portion and convey the light, e.g., by total internal reflection, to an output surface. The light source may be arranged to emit with a CCT of 3K to 20K, or over a daylight locus. The luminance profile may not vary by more than 20% over any circular area of 10 mm diameter. The light source may include a light guide to guide the light to the output light generation system or the other components of the output light generation system.

As used herein the term “chromatic system” may refer to an arrangement capable of imparting a particular colour to light, e.g., from the light source. The colour may be representative of the real-life colour of sky/sun light component, including daylight, sunset or sunrise. It may for example include a filter.

As used herein the term “collimated light generation system” may refer to a system for processing light from a light source to the collimated light. It may include one or more of the following collimating systems: a lens, including a Fresnel lens; a parabolic reflector; a closed cell structure, through the cells of which light is projected, and; other suitable system. The collimated light generation system may include a light source.

As used herein, the term “prism sheet” or may refer to an arrangement of prisms on a planar member, which maintain an initial degree of collimation of an incident light beam, but which expands said beam. The expansion may be achieved by reflection or reflection and/or refraction. An example of such an arrangement is disclosed in WO2017048569A.

As used herein, the term “electrical circuitry” or “circuitry” or “control electrical circuitry” may refer to one or more hardware and/or software components, examples of which may include: one or more of an Application Specific Integrated Circuit (ASIC) or other programmable logic; electronic/electrical componentry (which may include combinations of transistors, resistors, capacitors, inductors etc); one or more processors (e.g. circuitry structure of the processor); a non-transitory memory (e.g. implemented by one or more memory devices), that may store one or more software or firmware programs; a combinational logic circuit; interconnection of the aforesaid. The electrical circuitry may be located entirely at one component of the system, or distributed between a plurality of components of the system (e.g. a server system and/or external device) which are in communication with each other over a computer network via communication resources.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board or distributed as part of the system. As used herein, any machine executable instructions, or computer readable media, may be configured to cause a disclosed method to be carried out, e.g. by the system or components thereof as disclosed herein, and may therefore be used synonymously with the term method, or each other.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); Ethernet, DMX, or other protocol implementations. The device may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet; personal area networks (PANs), including with Bluetooth a short-range wireless technology standard.

As used herein, the term “external device” or “external electronic device” or “peripheral device” may include electronic components external to one or more of: the device, and; the server system, e.g. arranged at a same location or remote therefrom, which communicate therewith over a computer network. The external device may comprise a communication interface for electronic communication. The external device may comprise devices including: a smartphone; a PDA; a video game controller; a tablet; a laptop; or other like device.

As used herein the term “database” may refer to a data storage configuration which may be implemented as a key-value paradigm, in which an electronic record as a key and is associated with a value.

As used herein, the term “server system” may refer to electronic components external to one or more of: the device, and; the external device, e.g. arranged at a same location or remote therefrom, which communicate therewith over a computer network. The server system may comprise a communication interface for electronic communication. The server system can include: a networked-based computer (e.g., a remote server); a cloud-based computer; any other server system.

As used herein the term “virtual image” or “image” may refer to a reflection of a feature that is present in the output light in addition to the actual feature, but at a different position.

As used herein, the term “providing an appearance in output light” or like term, may refer to photons of light being perturbed e.g., spatially and/or chromatically by an item/feature of the optical device and made visible to a user by their projection/conveying to an eye of a user when gazing into the output aperture of the optical display device.

As used herein, the term “viewed from downstream of the output aperture” may refer to any and/or all viewing positions that are achievable by a user from downstream (e.g., from a side of a transparent member of the output aperture comprising an exterior face) the output aperture.

### [General System Description]

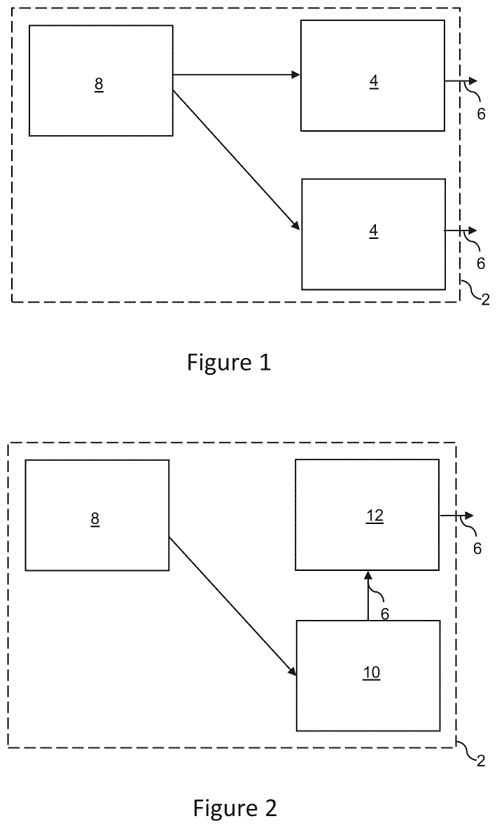

Referring to FIG. 1, the system 2 comprises: devices 4 for output of output light 6, and electrical circuitry 8 for control of various characteristics of the output light 6, as will be discussed. The electrical circuitry 8 may be distributed on one or more of: one or more of the devices 4; a server system (not illustrated); an external device (not illustrated).

In variant embodiments, which are not illustrated: the system comprises a single or other number of devices, in the instance of multiple devices, said devices can be arranged in series with each other as a combinatory assembly; each device comprises its own dedicated electrical circuitry rather than the electrical circuitry controlling multiple devices.

Referring to FIG. 2, a general device 2 comprises: an output light generation system 10 for generation of the output light 6; an output aperture 12 for of the output light 6, and the electrical circuitry 8 for control of the output light generation system 10. The output light 6 is generally projected in the depth directed 104, which is orthogonal to the plane of the output aperture 12.

### First Example

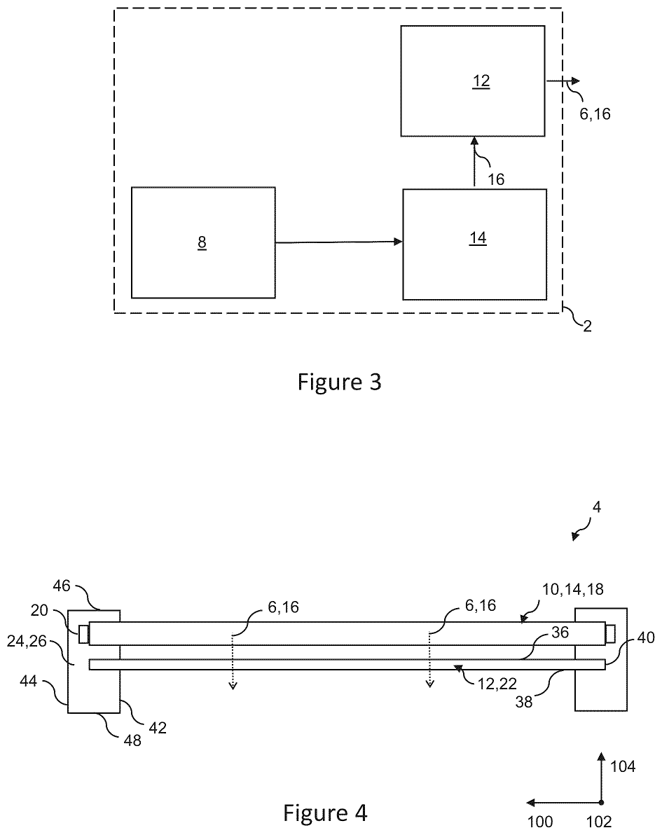

Referring to FIG. 3 a first example of the device 2, which incorporates features and associated variants of the aforedescribed general device 2, comprises the output light generation system 10 arranged as a diffuse light generation system 14. In the first example, the output light generation system 10 does not comprise a collimated light generation system, hence the output light 6 includes only a sky light component 16.

Referring to FIG. 4, in further detail the first example comprises the diffuse light generation system 14 arranged with a waveguide 18 and a light source 20. The output aperture 12 comprises a transparent member 22 and is defined by a frame 24. The device 2 includes a housing 26 to house said components.

The output aperture 12 is planar and is aligned in the longitudinal direction 100 and lateral direction 102. A thickness of the device 4 is arranged in the depth direction 104.

The frame 24 surrounds the transparent member 22 and gives an impression of a real-life window or skylight frame.

The light source 20 emits light in the longitudinal direction 100 into a side face of the waveguide 18. The waveguide 18 includes redirecting features (not illustrated) through its section which scatter the internally reflected light from the light source 20. The light emitted from the light source 20 is retained within the waveguide 18 by total internal reflection until it encounters a redirecting features and is scattered enabling it to exit the waveguide 18 as the diffuse sky light component 18.

In variant embodiments, which are not illustrated: the diffuse light generation system is alternatively configured; the uncoupling features are on an edge of the waveguide, which are configured to decouple the light therefrom; the diffuse light generation system comprises a backlit rather than an edge lit arrangement.

The transparent member 22 includes an interior face 36 that faces into the device 2, and into the output light generation system 10 and an exterior face 38 that faces away from the device 2 (which an observer gazes directly into) and a side face 40 extends between the interior face 36 and the exterior face 38 and around a periphery of the interior face 36 exterior face 38. The transparent member 22 is aligned in the longitudinal direction 100 and lateral direction 102.

The frame 24 includes: an interior side face 42; an outer side face 44; a top face 46, and; a bottom face 48. The top face 46 is arranged at a greater depth in the depth direction 104 than the bottom face 48.

### Second Example

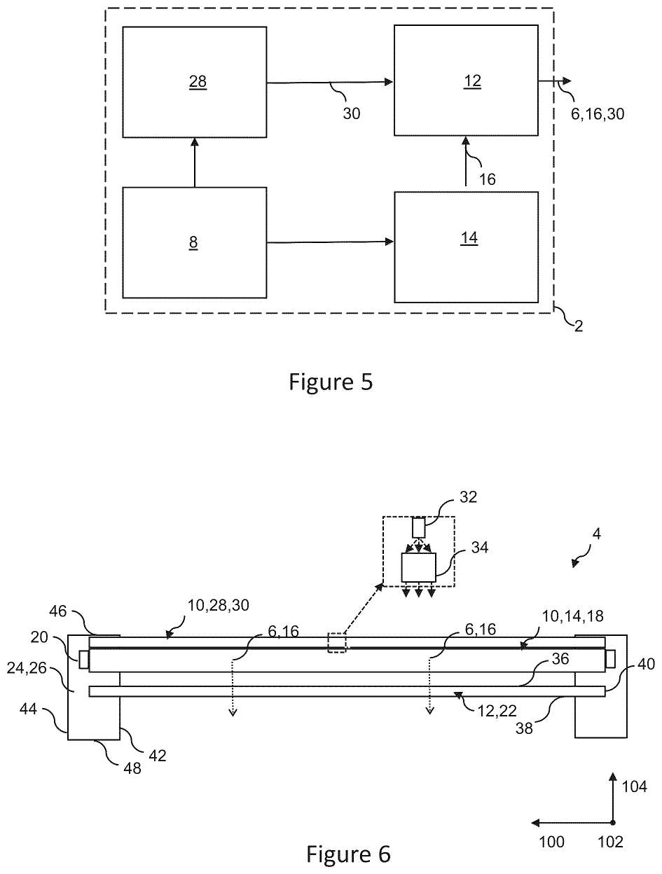

Referring to FIGS. 5 and 6 a second example includes the features of the first example and associated variants, but with the output light generation system 10 additionally implementing a collimated light generation system 28 to generate a sun light component 30.

The collimated light generation system 28 includes a light source 32 and a collimating system 34. The light source 32 projects a light beam (not illustrated) to the collimating system 34, which processes the received light beam to output collimated light which subsequently becomes the sun light component 30.

The light source 32 is implemented as a 2-dimensional array of LEDs, which can be arranged on a common substrate (not illustrated) that extends in the lateral direction 100 and the longitudinal direction 102. The collimating system 34 is implemented as a 2-dimensional array of lenses (not illustrated), each of which being associated with an LED. A homogenising element (not illustrated) may optionally be implemented subsequent to the collimating system 34 to remove stray light which may be introduced by the collimating system 34 and/or the light source 32, e.g. as an absorbent honeycomb through which the collimated light passes.

In variant embodiments, the collimated light generation system is alternatively implemented, including: as a single or 1-dimensional array of light sources, which are expanded over the output aperture, e.g. by using an expansion system, which can include one or more reflective members and prism sheets, and; the collimating system is alternatively implemented as parabolic reflectors or other collimating systems; the collimated light generation system is implemented as a laser light source, which may obviate the collimating system. The collimated light generation system may also be separate from the diffuse light generation system, e.g., as a spotlight.

### [Distant Object Generation System]

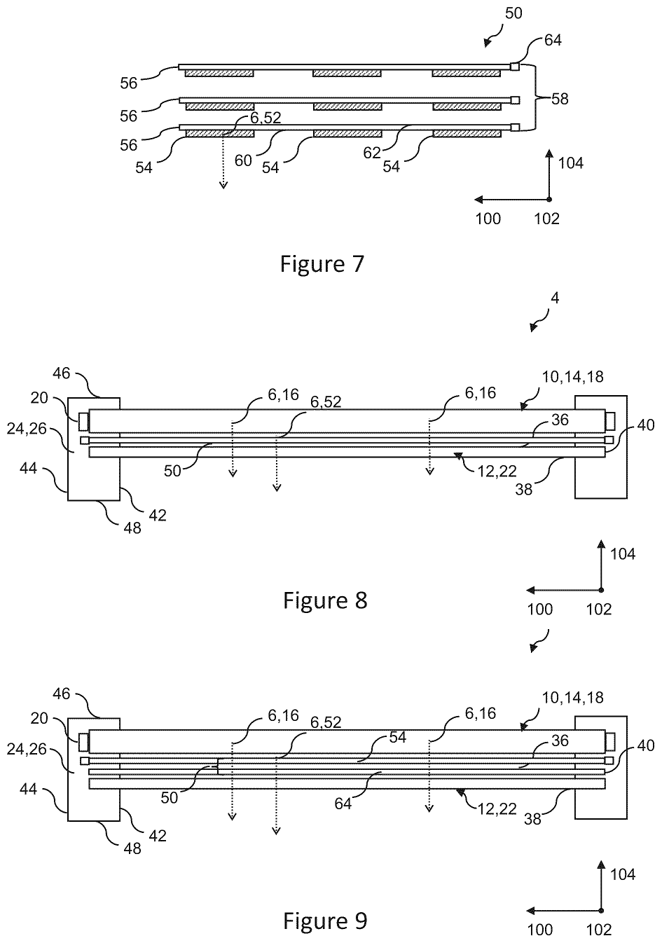

Referring to FIGS. 7 and 8, in a third example, the optical display device 2 includes a distant object component generation system 50, which may be implemented as a subcomponent of the output light generation system 10. The distant object component includes one or more features with a distant depth, as will be discussed. In the examples, the or each feature 52 is a cloud, and hence is referred to as a cloud component.

In the third example, the distant objected generation system 50 is integrated in the first or second example optical display devices 2, which are discussed above (e.g. and is positioned downstream of the diffuse light generation system 14).

Referring to FIG. 7, the distant object generation system 50 comprises light control members 54, which are configured for manipulation of the output light 6 to create the perception of one or more features in the sky scene as the distant object component.

The light control members 54 are arranged on an optically transparent substrate 56 in layers 58. There are three optically transparent substrates 56, each with a first face 60 and a second face 62. The first face 60 faces the output aperture 12 (not illustrated in FIG. 7) and the second face 62 faces away from the output aperture 12. The light control members 54 are arranged on the first face 60, hence there are three layers 58 of light control members 54.

In variant embodiments, which are not illustrated: there are other numbers of optically transparent substrates e.g., 1 or 4 or 5; the light control members may be arranged on both faces or just the second face of the optically transparent substrates; the optically transparent substrate may alternatively be implemented as a carrier medium which carries the light control members, for example, and arrangement where the light control members and optically transparent substrate are both printed as a single unit by 3-d printing.

The optically transparent substrates 56 are arranged parallel to and separated from each other in the depth direction 104. In variant embodiments, which are not illustrated: the optically transparent substrates are alternatively arranged, including together, e.g., as a laminate.

Referring to FIG. 8, the distant object generation system 50 is shown integrated in the first example. The optically transparent substrates 56 are arranged parallel to an extend over the output aperture 12 and are arranged downstream of the waveguide 18, such that light from the waveguide passes through the optically transparent substrates 56 to the output aperture 12.

As best seen in FIG. 7, the distant object generation system 50 comprises a light source 64 arranged to project light in the longitudinal 100 and lateral 102 direction to the light control members 54 from an edge of the optically transparent substrates 56. Such an edge lit arrangement contains the light in the optically transparent substrates 56 as a waveguide until it encounters a light control member 54, which causes the light to be decoupled from the optically transparent substrates 56 and projected as the or each feature 52 of the distant object component. Alternatively, dedicated redirecting features (e.g. surface discontinuities, including prisms) may be implemented on the transparent substrates 56 to decouple light and redirected it to the light control members.

The arrangement of the light control members 54 may be determined by numerical analysis. For example, an input into a computer simulation of the distant object generation system 50 comprises a desired target image of one or more features to be created in the sky scene, which can be sampled from a real life sky. A feature extraction algorithm such as Orb may be implemented to extract the clouds as one of more features of the distant object component from the target image. Subsequently, the computer simulation determines the arrangement of the light control members 54 to give the same impression of the clouds of the target image at multiple viewing positions. The arrangement of the light control members 54 may be provided in terms of one more of: a spatial arrangement; an emission, and; an absorption of the light control members.

The computer simulation may implement one or more of: Nonnegative Matrix Factorization NMF; Fourier Domain Analysis, and; other computational technique to determine a position and/or emission/absorption band of the light control members to achieve recreation of the or each feature.

In the third example the light control members 54 are configured to absorb wavebands of the light projected to them to create the perception of the clouds. For example, they may have a suitable colour transparency.

In a fourth example (which is a variant of the third example) the light control members alternatively emit 54 a diffuse sky light component, and the waveguide 18 of the first or second example is alternatively configured to emit a colour (e.g. white/grey) of the distant object component.

Referring to FIG. 9, in a fifth example the light source 64 is alternatively arranged as a transparent panel, which is arranged parallel to and over the output aperture 12, downstream of the light control members 54 (e.g. between the light control members 54 and the output aperture 12), to project light in an upstream direction (e.g. the depth direction 104) to the light control members 54, with the light being reflected back from the light control members 54 in the counter depth direction 104 through the light source 64 and out through the output aperture 12.

In a sixth example (which is a variant of the third example), referring to FIG. 8 the light control members 54 are alternatively configured as light sources, e.g. as OLEDs, to emit particular wavebands as the distant object component. In a variant of this example (which is not illustrated) the OLEDs may also emit the diffuse sky light component (e.g., as the clear sky component) in addition to the distant object component. In other variant embodiments, the light control members arranged as emitters are alternatively configured, e.g., as other LEDs, pixels or other sources.

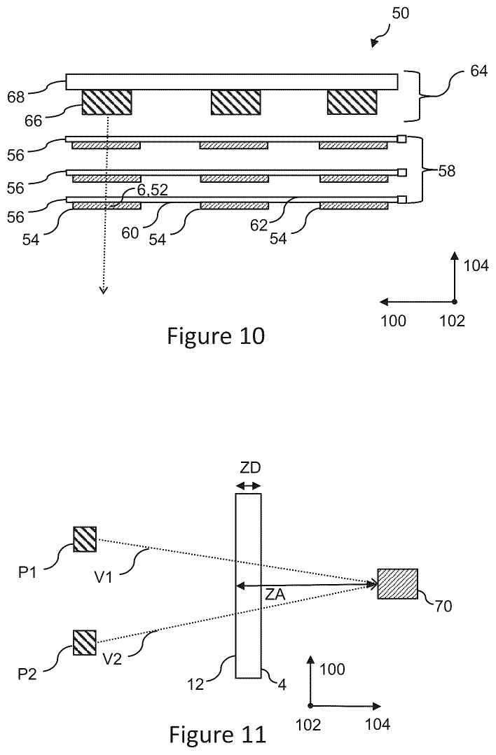

Referring to FIG. 10, in a seventh example the light source 64 comprises an arrangement of sources 66 that are positioned in alignment (when viewed in a longitudinal and lateral plane) with the light control members 54. The light source 64 may for example comprise an array of point sources 66 that can be arranged on a common substrate 68, with each individual point source projecting to a dedicated light control member 64. The common substrate 68 may be transparent to enable light from the diffuse light generation system 14 (not illustrated in FIG. 10) to pass through. Hence the seventh example may be implemented in either of the first or second examples between the waveguide 18 and output aperture 12 or upstream of the waveguide 18. Alternatively, in the seventh example, the point source effect may be achieved with a waveguide with a redirecting/decoupling features forming said point sources where the light is decoupled from the waveguide.

The array of sources 66 of the seventh example can be positioned upstream (as illustrated) or downstream (as for the fifth example) of the light control members.

In a eighth example (which is not illustrated) the light source is alternatively arranged as a panel, which may be arranged parallel to and over the output aperture, that is upstream of the light control members (e.g. to project light to the light control members and the output aperture without back reflection contrary to the fifth example). The panel may be implemented as a waveguide with redirecting features or as surface features on a substrate.

In the various examples diffuse or collimated light can be projected to the light control members 54. Collimated light may have a greater coupling efficiency, and may be conveniently implemented for the seventh example, that is the point sources emit directional light to the light control members. The light may be collimated by an array of lenses (not illustrated), with each light source arranged aligned to a lens.

Whilst the light control members 54 are in general exemplified as forming the distant object component 52 with the diffuse light generation system 12 producing the sky light component 16, all suitable examples may alternatively be configured with the converse. For example, the diffuse light generation system produces a white/grey diffuse background as a cloud component of the distant object component, and the light control member provide a blue diffuse sky light component over this background. With such arrangements in mind, the output light generation system may be referred to more generally as comprising comprises a colour emission system, which can be arranged to emit a colour of the distant object component or the diffuse sky light component. The colour emission system may emit a diffuse background colour, e.g. a diffuse sky light component, that surrounds the emission from the light control members, e.g. clouds, or the converse.

As best seen in FIG. 7, the light control members 54 between adjacent layers 58 are arranged aligned in the depth direction 104 to each other. Specifically, a centroid of the light control members 54 is aligned along a common axis aligned in said depth direction 104. The light control members 54 are arranged with the same longitudinal pitch in the longitudinal direction 100 and the same lateral pitch in the lateral direction 102. The pitch can be defined as a distance in either of said directions between adjoining centroids of the light control members 54. The longitudinal pitch and the lateral pitch may be the same or different. The size of the light control members 54 is the same in the longitudinal, lateral and depth directions. The light control members 54 are arranged with the same depth pitch in the depth direction 104, with may be the same as the longitudinal pitch and the lateral pitch. Such an arrangements may permit creation of the cloud component with the Moiré effect.

In variant embodiments, which are not illustrated other arrangements of the light control members are implemented, for example: non-equal pitch in one or more of the longitudinal, lateral and depth directions; light control members of different sizes; light control members of different absorbance and/or emission, e.g. as colours.

From the above examples, it will be understood that the light control members may have various implementations:
1) Transparent to one or more visible wavebands of incident light. In a particular example, the light control members can be arranged as domes, e.g. as printed formations, to have a lens effect to distribute the incident light to a flat face of the dome arranged on the substrate.
2) Reflective, to one or more visible wavebands of incident light, including diffusely reflective.
3) Arranged as light sources, e.g. as LEDs.

Whilst the above examples make reference to the or each feature of the distant object component being a cloud component (e.g. clouds), it will be appreciated that said feature(s) can be extended to other distant objects via the same principles. For example, a horizon and/or buildings may be recreated in addition to or instead of the cloud.

Referring to FIG. 11, the distant object generation system is configured to generate one or more features 70 that appear to an observer gazing into the output aperture 12 to be at an apparent depth ZA beyond a physical depth ZD of the device 4. ZA may be at least 20×ZD.

ZA is determined by projecting line of sight vectors V1, V2 from a first viewing position P1 and a second viewing position P2 through the output aperture 12 to a perceived location of the one or more features 70. ZA represents a distance from the output aperture 12 to a convergence point of these vectors beyond the physical depth ZD of the device.

It will be understood that the angles between the line of sight vectors V1, V2 at the viewing positions P1, P2 can be determined, e.g.: by eye tracking software in the event that human eyes are represented by P1 and P2; or by angles of cameras at P1, P2, arranged to focus on the feature 70. The distance between P1 and P2 is known as is the distance from the output aperture 12. Hence trigonometric relationships can be used to calculate ZA.

### Further Examples

Further examples, that may be combined with the preceding examples/embodiments, will now be described:

This disclosure relates to an innovative artificial skylight system designed to simulate dynamic sky environments, including clouds and optionally the sun, within indoor settings. The system's key feature is its adaptability, accommodating various configurations to suit diverse installation requirements and aesthetic preferences.

The core innovation lies in the system's ability to simulate the motion and appearance of clouds in a sky-like vista, creating the effect of clouds maintaining their position relative to the observer as they move beneath the artificial skylight. This is achieved through a novel assembly of stacked layers, each playing a crucial role in the cloud simulation. The system's design allows for multiple configurations of the topmost layer, which can be either transparent or opaque, depending on the desired outcome of the installation.

In the transparent configuration, the top layer functions as a light guide panel, facilitating the integration of a sun-like light source to complement the cloud display. This configuration is ideal for creating a more holistic sky experience, where both the sun and clouds are visible. Conversely, the opaque configuration focuses exclusively on replicating the appearance of the sky and clouds, suitable for scenarios where the simulation of the sun is not required.

The lower layers of the system consist of thin, light-manipulating panels, such as acrylic or similar materials, imbued with specifically designed dot patterns (which are referred to herein as light control members). These patterns are responsible for creating the depth and movement of the cloud display and can be illuminated in various ways, including but not limited to side illumination. The precise formulation and arrangement (e.g. in terms of one or more of size, position, spacing, number per layer); an emission, and; an absorption) of these dot patterns may be determined through sophisticated computational methods, such as Nonnegative Matrix Factorization (NMF), ensuring a realistic and consistent depiction of clouds across all layers.

Additionally, the system employs Fourier Domain Analysis or equivalent techniques to maintain image consistency across different viewing angles, a vital aspect in reinforcing the illusion of clouds moving with the observer.

This artificial skylight system is versatile and adaptable, offering a transformative approach to indoor space enhancement. It can be applied in diverse environments, ranging from residential to commercial settings, where creating a connection to the natural environment is desired. The system is not only aesthetically pleasing but also potentially beneficial for mental well-being, mimicking the calming effects of a natural sky. This disclosure represents a significant advancement in the field of artificial sky simulation, combining optical innovation with advanced computational techniques to accurately and dynamically replicate the varying aspects of the sky.

Traditional methods of introducing natural sky elements into architectural spaces, such as skylights, are limited by structural and geographical constraints. While recent advancements in display technology have led to the development of artificial skylights, these often lack the ability to convincingly simulate dynamic sky phenomena, especially the movement of clouds and the transitions of sunlight.

Current artificial skylight systems, utilizing static or semi-dynamic display methods like backlit panels or LED arrays, fall short in authentically replicating the dynamic nature of the sky. They typically do not provide the illusion of depth or the perception of clouds at optical infinity.

Key factors in the development of artificial skylight systems include energy efficiency, broad spectral output, and high color fidelity. These aspects are crucial for creating a realistic sky simulation while addressing environmental and operational considerations.

Despite advancements in this field, there remains a significant challenge in creating a system that can dynamically simulate clouds appearing at optical infinity. Such a system should give the impression that the clouds are distant and move relative to the observer, thereby enhancing the realism of the indoor sky experience.

The primary objective of this disclosure is to address these challenges by introducing a sophisticated artificial skylight system designed to simulate clouds at optical infinity. The system aims to create a dynamic and immersive indoor sky experience, where the clouds appear to be at a significant distance and move in tandem with the observer. This effect is achieved through a novel combination of layered optical elements, advanced light manipulation techniques, and computational image processing. The disclosure is designed to be adaptable, with configurations for both transparent and opaque top layers, catering to varying indoor applications. The focus is on achieving a high degree of realism in the cloud simulation, alongside energy efficiency, wide spectral output, and excellent colour fidelity, thus significantly enhancing the aesthetics and ambiance of indoor environments.

The present disclosure relates to an artificial skylight system designed to simulate clouds at optical infinity. This system creates a dynamic visual experience wherein clouds appear at a significant distance and seem to move synchronously with the observer's movements beneath the skylight. The disclosure is particularly characterized by its adaptability in design and functionality, catering to diverse indoor environments and aesthetic preferences.

### Technical Aspects of the Disclosure

The proposed system is characterized by a meticulously structured layered design, each layer functioning synergistically to create a compelling illusion of depth and the dynamic motion of clouds. Central to this system are the following components and functionalities:

### 1. Top Layer Configurations and Characteristics.

Transparent Light Guide Panel: This variant of the top layer serves a dual function. It acts as a conduit for a sun-like light source while simultaneously participating in the cloud simulation. The panel's transparency allows for the passage and manipulation of light in a way that mimics the natural interplay of sunlight with clouds.
Opaque Layer for Cloud Simulation: Alternatively, the top layer can be configured as an opaque element, dedicated exclusively to depicting clouds. This configuration is particularly adept at enhancing the depth and intricacy of cloud formations.
Sky Mimicry in Illumination: Regardless of the configuration, the top layer's illumination is engineered to replicate the color, spectrum, and intensity of a real sky. This includes a predominantly blue hue during daytime simulations, adjusting to warmer tones to represent sunrise or sunset conditions, thereby enhancing the system's authenticity.

### 2. Light-Manipulating Lower Layers.

Material Composition and Function: Beneath the top layer lies a series of thin, light-manipulating layers, typically composed of acrylic or similar materials. These layers are integral to the cloud simulation process.
Etched Dot Patterns for Depth and Movement: Embedded within these layers are strategically etched dot patterns. These patterns are meticulously designed to manipulate light in a manner that convincingly emulates the appearance and movement of distant clouds.
Light Interaction for Cloud Simulation: The dot patterns play a pivotal role in creating the perceived depth of the clouds. By varying the density and arrangement of these dots, the layers can effectively simulate the dynamic and ever-changing nature of cloud formations.

### 4. Adaptability and Energy Efficiency.

The disclosure is designed to be highly adaptable, with the capability to switch between transparent and opaque top layers, depending on the installation requirements.
Energy efficiency is a key consideration in the design, ensuring that the system is not only visually effective but also environmentally sustainable and cost-effective in its operation.
The system also boasts a wide spectral output and high color fidelity, essential for creating a realistic and vibrant simulation of the sky.

### 5. Application and Utility

The artificial skylight system is particularly beneficial for indoor environments where natural sky views are inaccessible, such as underground spaces, windowless rooms, or regions with limited natural light.

By simulating the dynamic nature of the sky, the system adds aesthetic value, enhances the ambiance of indoor spaces, and may contribute positively to mental well-being.

This summary provides a comprehensive overview of the disclosure, detailing its unique features, technical aspects, and potential applications. It positions the disclosure as an innovative solution in the field of artificial environmental simulation, specifically for creating a realistic and dynamic indoor sky experience.

### Section 4.1 System Components

### 1. Layered Structure.

4.1.1 Top Layer Variability: The topmost layer of the system is pivotal in achieving the desired visual effect and can be adapted based on specific requirements:
   Transparent Configuration: This variant acts as a light guide panel, allowing for the passage and manipulation of light from additional sources, such as a simulated sun.
   Opaque Configuration: Focuses on cloud simulation, excluding the representation of the sun, and enhances the depth and intricacy of the cloud imagery.

### 2. Dot-Patterned Layers for Cloud Simulation

4.1.2 Light-Attenuating Layers: These layers function by blocking selective wavelengths from a backlight positioned behind them. The dot patterns on these layers are designed to variably attenuate light, thereby creating a realistic cloud simulation. This selective attenuation is key to representing the varying densities and formations of clouds.
4.1.3 Light-Emitting Layers: In configurations where an additional light source is required, the layers can include light-emitting elements:
   Side-Illuminated LGP: For certain configurations, light can be injected into a Light Guide Panel (LGP) from the sides, with the dot patterns dispersing this light to create a cloud-like appearance.
   Electroluminescent Elements: In cases where electrical illumination is preferable, technologies such as OLED can be utilized. Here, each dot or pixel can emit its own light, offering precise control over the intensity and color of the cloud imagery.

### 3. Illumination and Control Systems

4.1.4 Illumination Techniques: Depending on the layer type, the system employs different illumination techniques to achieve the desired effect.
   Backlighting for Attenuating Layers: A uniform and diffused backlight source provides the necessary illumination for the attenuating layers, with the dot patterns modulating this light.
   Integrated Illumination for Emitting Layers: Layers with OLED or similar technologies have built-in illumination capabilities, negating the need for external light sources.
4.1.5 Control and Image Processing: The system includes advanced control units and image processing algorithms to manage the cloud display:
   Algorithmic Image Processing: Techniques like NMF and Fourier Domain Analysis ensure that the cloud patterns are realistic and consistent across viewing angles.
   Customizable Control Interface: Users can interact with the system via an interface to adjust the cloud display, adapting it to various environmental settings.

### 4. Energy Efficiency and Spectral Output

4.1.6 Energy-Efficient Design: The system is engineered for optimal energy efficiency, leveraging advanced lighting technologies to minimize power consumption while maintaining visual effectiveness.
4.1.7 Spectral and Color Fidelity: Ensuring a wide spectral output and high color accuracy, the system accurately replicates the diverse and vibrant hues found in natural sky scenes.

### Section 4.1.5 Computational Techniques for Layer Design

In designing the layered structure of the artificial skylight system, several computational approaches can be employed to accurately solve for the dot patterns required for each layer. These methods ensure the realistic portrayal of clouds at optical infinity, contributing to the dynamic visual experience of the system. For most methods, the process works to iteratively solve for a solution where when viewed from different angles, the scene appears to be at optical infinity.

### A. Nonnegative Matrix Factorization (NMF)

Objective and Methodology: NMF is used to decompose the visual data of cloud formations, encoded in a matrix format, into two or more matrices with nonnegative elements. These resultant matrices represent the individual layers' dot patterns. The factorization aims to minimize reconstruction error, ensuring accuracy in cloud simulation.
Advantages: NMF is particularly effective due to its ability to handle non-negative data, aligning well with the physical properties of light and color in the context of cloud simulation.

### B. Alternative Computational Approaches

### 1. Genetic Algorithms (GAs)

Application: GAs can iteratively refine the dot patterns, using evolutionary strategies such as mutation and selection to arrive at an optimal solution for realistic cloud depiction.

### 2. Convolutional Neural Networks (CNNs).

Application: CNNs, trained on a dataset of sky images, can learn and predict the most effective dot patterns for various lighting conditions and cloud formations.

### 3. Simulated Annealing

Application: This probabilistic technique gradually converges on a globally optimal solution, ideal for exploring and refining complex dot patterns in the layers.

### 4. Ray Tracing Algorithms

Application: By simulating light interactions with proposed dot patterns, ray tracing can aid in adjusting the patterns for accurate light scattering and cloud appearance.

### 5. Gradient Descent Optimization

Application: This iterative optimization algorithm can be used to fine-tune the dot patterns by continuously adjusting them to minimize the difference between the simulated and target cloud images.

### 6. Monte Carlo Methods

Application: These stochastic algorithms can solve the dot pattern problem by randomly sampling and evaluating various configurations to approximate the ideal pattern distribution.

### 7. Machine Learning

Application: This set of algorithms including Neural Networks, can be used to train a model on a set of input cloud images (or other images which are consistent with the embodiments disclosed herein) and output layers to synthesize new layers quickly after training has been performed.

### Use of Simulation for Viewpoint Analysis

Testing and Validation through Simulation
Objective: The disclosure employs advanced simulation techniques to validate and refine the dot patterns on each layer, ensuring that the cloud simulation maintains its realism and continuity from various viewpoints.

### A. Simulation for Different Viewpoints

### Methodology:

Multi-Angle Simulation: The system simulates the appearance of the artificial sky from multiple angles and positions, replicating the varied viewpoints of different observers.
Viewpoint Replication: This process involves creating virtual models of the skylight system and rendering images as they would appear to an observer moving beneath or around the skylight.
Consistency Check: The primary goal is to ensure that the clouds appear at optical infinity consistently from these varied viewpoints, maintaining their relative position and appearance.

### B. Error Analysis and Optimization

Error Metrics: Quantitative measures of error between the simulated images and the desired outcome (clouds at optical infinity) are calculated. These metrics may include factors such as continuity of appearance, relative motion consistency, and visual coherence. When high resolution dots are used they may not be directly visible to the eye, in such cases we use a lower resolution version of the ray traced image to measure the error which would be visible to a human eye.
Iterative Refinement: Based on the error analysis, adjustments are made to the dot patterns. This iterative process involves recalculating the dot patterns using the chosen computational technique (e.g., NMF, CNNs) and re-running the simulation until the error metrics fall within acceptable thresholds.
Thermal Expansion in simulation. In some embodiments, optimization of layer dot patterns can include tolerances for thermal expansion, so as to minimize the effect of small changes in sizes due to thermal expansion.
   C. Integration with Computational Techniques
Complementary Use: The simulation and error analysis are used in conjunction with computational techniques like NMF or CNNs. The output from these algorithms serves as input for the simulation, and the insights gained from the simulation feed back into further computational refinements.
Feedback Loop: This creates a feedback loop where computational methods and simulation inform and enhance each other, leading to a progressively more accurate and realistic cloud simulation.

### Section 4.3 System Variants

The artificial skylight system, designed to simulate dynamic sky environments, is characterized by its versatility in configuration. This adaptability allows the system to cater to a wide range of installation requirements and aesthetic preferences. The following are key variants of the system:

### 1. Variability in the Top Light Source.

4.3.1 Opaque Light Panel: This variant utilizes an opaque top layer that diffuses light uniformly, ideal for simulating overcast sky conditions or evenly lit cloud formations.
4.3.2 Transparent Light Panel: In this configuration, the top layer is transparent, allowing for the integration of an additional sun-like light source. This variant is suitable for scenarios where a representation of the sun, alongside clouds, is desired.

### 2. Configuration of Individual Layers.

4.3.3 Attenuating vs. Emitting Layers: The system can comprise layers that either attenuate light from a backlight source or are self-illuminating.
   Attenuating Layers: These layers block or filter light to create the cloud patterns. They are typically backlit and can use various materials, including inkjet-printed films or etched acrylic.
   Emitting Layers: Self-illuminating layers can employ technologies like OLED, where each dot emits its own light, offering greater control over intensity and color.
      3. Static vs. Dynamic Layers.
4.3.4 Static Layers: Static configurations use permanently etched or printed dot patterns, ideal for fixed cloud formations.
4.3.5 Dynamic Layers: Incorporating layers with dynamic display technologies, such as LCD or OLED panels, allows for changing cloud formations. This variant can simulate the natural evolution of cloud patterns over time.

### 4. Illumination Methods for Layers.

4.3.6 Side Illumination: Some variants employ side illumination for the layers, where light is injected from the edges to activate the dot patterns.
4.3.7 Self-Illumination: In the case of OLED or similar technologies, layers can self-illuminate, eliminating the need for external light sources.
4.3.8 Attenuation of Top Layer Light: Layers can also be designed to attenuate light from the top light source, contributing to the overall cloud simulation effect.

### 5. Dot Color and Frequency Variability

4.3.9 Single Color Dots: This simple variant uses dots of a single color, suitable for monochromatic cloud simulations.
4.3.10 Multi-Frequency Dots: More advanced configurations can have dots that emit or block specific light frequencies, allowing for the creation of colored cloud formations with varying hues and intensities.

### Configuration Strategies for Static Cloud Simulations in Multi-Skylight Systems

### 1. Consistent Visualization in Uniform Installations

Uniform Installation Protocol: In scenarios involving multiple skylights with static cloud imagery, each skylight is configured to ensure uniformity in visual perception from varied observer positions. This uniformity is achieved by standardizing the orientation and angular placement of each skylight unit.
Design for Visual Continuity: The cloud patterns within each skylight are calculated and designed to maintain seamless visual continuity, ensuring that as an observer traverses beneath multiple units, the cloud formations appear as a singular, cohesive skyscape.

### 2. Customized Pattern Design for Varied Angular Installations

Tailored Configurations for Diverse Angles: Addressing installations where skylights are positioned at differing angles, such as in vaulted ceilings, each unit is equipped with a uniquely calculated cloud pattern. These patterns are designed to align collectively, presenting a unified cloud formation across the installation.
Computational Design Methodology: Employing advanced algorithms, the cloud patterns for each skylight are computed considering the specific installation angle and perspective geometry. This ensures optical consistency in cloud formations across all units, irrespective of their individual orientations.

### 3. Optical Properties and Aesthetic Considerations

Ensuring Optical Uniformity: Key optical factors, including light diffusion and refraction, are meticulously calibrated within each skylight unit. This calibration is crucial for maintaining the uniform appearance of clouds across units with differing installation angles.
Architectural Integration: The design of each skylight unit takes into account the aesthetic and architectural nuances of the installation space, ensuring that the system not only functions optimally but also enhances the spatial ambiance.

### 4. Installation and User Experience

Simplified Alignment and Mounting: The system is engineered for ease of installation, with a focus on straightforward alignment procedures to accommodate the varied angles of skylight units.
Enhanced Visual Engagement: Despite the static nature of the cloud imagery, the strategic design of the cloud patterns ensures a dynamic and immersive visual experience for occupants, effectively simulating the presence of a natural sky overhead.

### Dynamic Content Integration for Enhanced Realism in Multi-Skylight Systems

### 1. Introduction to Dynamic Content Layering.

Dynamic Content Overview: The multi-skylight system is enhanced with the capability to display dynamic content, such as leaves, birds, and tree branches, in addition to the primary cloud simulation. This content, being closer to the observer, is depicted with sharper detail, contrasting with the softer, more distant cloud formations to enhance depth perception and realism.

### 2. Detailed Content Display.

Foreground Layer Detailing: Dynamic elements that are intended to appear closer to the observer, such as fallen leaves on the skylight surface or birds flying overhead, are rendered with high-resolution detail. This sharpness in the foreground layer creates a striking contrast with the blurry infinity-focused clouds, adding to the system's depth and realism.
Content Rendering Techniques: Advanced rendering techniques are employed to depict these elements with lifelike accuracy and motion. The system uses high-definition imagery and animation to simulate the natural movements of these elements, such as the fluttering of leaves or the flight of birds.

### 3. Integration of Foreground and Background Layers

Layer Integration Strategy: The system is designed to seamlessly integrate dynamic foreground content with the static or semi-dynamic background cloud layers. This integration is managed through sophisticated image processing algorithms that ensure cohesive visual transitions between the layers.
Variable Focus Mechanism: A variable focus mechanism is employed, allowing the system to adjust the clarity and sharpness of different content layers dynamically, based on their perceived distance from the observer.

### 4. Content Management and Control

Customizable Content Control: The system includes an interface for customizing and controlling the dynamic content. Users can select, modify, or schedule specific elements like bird animations or leaf patterns to suit different themes or preferences.
Real-Time Content Adaptation: Real-time adaptation capabilities enable the system to alter the dynamic content based on external factors, such as weather conditions or time of day, further enhancing the system's interactivity and engagement.

### 5. Application and User Experience

Enhanced Environmental Simulation: The inclusion of dynamic content adds a layer of interaction and engagement, making the artificial skylight system more than just a visual display, but an immersive experience that closely mimics the outdoor environment.
Versatility in Use Cases: This feature is particularly beneficial in settings where a connection to nature is desired, such as in healthcare facilities, residential spaces, and commercial areas seeking to create a tranquil and natural atmosphere.
   System Parameter ranges

### 1. Dot Size:

Minimum Size: Approximately 10 micrometers (μm). This size is small enough to ensure high resolution and detail for the cloud and sky simulations and approaches the minimum size of today's inkjet printers.
Maximum Size: Up to 1 millimeter (mm). Larger dots can be useful for creating broader, more diffused light effects, suitable for softer cloud formations or less detailed aspects of the display.
Rationale: This range covers a spectrum from high-detail to more diffused lighting effects, ensuring versatility in the visual output of the system.

### 2. Layer Thickness:

Minimum Thickness: Around 0.1 millimeters (mm). Thinner layers can allow for finer control of light transmission and more detailed imagery.
Maximum Thickness: Up to 5 millimeters (mm). Thicker layers might be used for more diffuse light scattering or when incorporating more robust or complex lighting elements.
Rationale: This range accommodates various material choices and lighting technologies, allowing for flexibility in design and functionality.

### 3. Number of Layers:

Minimum Number: At least 2 layers. A basic configuration for creating a minimal depth effect and a simple sky simulation.
Maximum Number: Up to 10 layers or more. More layers allow for a more complex and nuanced simulation of sky and cloud dynamics, offering enhanced depth and realism.
Rationale: A range of 2 to 10+ layers allows for simple to highly complex sky simulations, catering to a wide variety of installation needs and visual effects.
   Integration with Real-Time Sky Monitoring System for Cloud Simulation
   1. System Integration with Outdoor Monitoring Camera
Purpose and Functionality: The disclosure can integrate with an outdoor monitoring system, including a camera designed to capture real-time images of the sky. This camera, while not necessarily high-resolution, is configured to effectively capture the essential characteristics of the sky, such as cloud formations, sky color, and intensity.

### 2. Image Processing for Cloud Simulation

Image Analysis for Cloud Attributes: The captured images are analyzed to extract key attributes relevant to cloud simulation. This analysis includes the determination of cloud size, apparent wind speed (inferred from cloud movement), sky color, and light intensity.
Specific Image Processing Steps:
   Cloud Size Adjustment: Algorithms are utilized to scale the cloud sizes appropriately for the indoor display, ensuring that the cloud proportions match the perceived distance in the indoor setting.
   Wind Speed Replication: The system replicates the observed wind speed in the cloud movement within the artificial skylight, providing a dynamic and realistic simulation.
   Sky Color Matching: The color tones captured in the images are used to adjust the color palette of the skylight display, ensuring that the indoor sky color matches the outdoor conditions.
   Intensity Calibration: The overall brightness and intensity of the skylight are adjusted in accordance with the outdoor light conditions, providing a consistent experience between the indoor and outdoor environments.

### 3. Dynamic Adjustment and Synchronization.

Real-Time Adaptation: The system is designed to continuously adapt the indoor sky simulation based on the real-time data received from the outdoor monitoring camera. This dynamic adjustment ensures that the indoor sky representation is synchronized with the actual outdoor conditions.
Manual Override and Control: While the system primarily operates in an automated mode, manual controls are available to adjust the cloud simulation, wind speed replication, sky color, and intensity as per specific user requirements or preferences.

### 4. Application and User Experience.

Enhanced Realism and Connectivity: By mirroring the outdoor sky conditions, the system offers an enhanced sense of realism and a stronger connection to the natural environment, particularly beneficial in enclosed or windowless spaces.
Customization for Various Environments: The adaptability of the system makes it suitable for a wide range of environments, from residential to commercial settings, where replicating the natural dynamics of the sky is desired.

### Multi-Channel LED Integration for Dynamic Sky and Cloud Color Simulation

### 1. Introduction to Multi-Channel LED Configuration

Purpose and Functionality: The disclosure is equipped with a multi-channel LED system, particularly integrated along the length of the Light Guide Panels (LGPs) in the layer stack. This advanced lighting system is designed to independently control the color of the sky and clouds, enabling dynamic color simulations, such as emulating a sunset.

### 2. Mechanism of Color Variation.

Multiple LED Channels: The system employs LEDs capable of emitting different colors, organized in multiple channels. These channels can be individually controlled to adjust the color emitted by each set of LEDs.
Localized Color Control: By positioning these multi-channel LEDs strategically along the LGP, the system can create localized color effects. This allows for the sky to maintain a blue hue while the clouds transition to warmer colors, mimicking the natural color variations seen during a sunset.

### 3. Synchronization and Control of LED Channels

LED Channel Synchronization: The LEDs are synchronized to gradually change the cloud colors while keeping the sky color constant. This synchronization is achieved through precise control algorithms that manage the intensity and color output of each LED channel.
Control System: The system includes a control interface, enabling manual adjustments or pre-programmed settings for specific sky scenarios, such as sunsets or sunrises. The control system ensures seamless transitions between different color states.

### 4. Application of LGP Technology

LGP Color Distribution: The LGPs are designed to distribute the light from the multi-channel LEDs evenly across the layers. This even distribution is key to creating a realistic emulation of natural sky phenomena, ensuring that the color changes appear natural and consistent across the skylight surface.
Optimization for Sunset Simulation: The system is optimized for scenarios like sunset simulations, where the clouds gradually shift to warmer tones against a contrasting blue sky, creating a visually stunning and realistic effect.

### 5. User Experience and Environmental Enhancement.

Enhanced Ambiance: This feature significantly enhances the ambiance of indoor spaces, providing occupants with a dynamic and visually engaging representation of the natural sky.
Customizable Sky Experiences: The multi-channel LED system allows for a range of customizable sky experiences, catering to different aesthetic preferences and environmental conditions.

### Diverse Implementation Methods for Horizon Simulation in Window-Like Display System

This section of the patent application delineates various implementation methods for a window-like display system designed to simulate a dynamic horizon view. This system, distinct from the previously discussed cloud skylight version, focuses on creating a realistic portrayal of the horizon, as viewed through a conventional window. While the cloud skylight system is oriented towards simulating an overhead sky with cloud formations, the window-like system aims to replicate the appearance of a distant horizon with its unique visual characteristics. Although the multiple dot layers is not capable of achieving infinity focus of objects with sharp edges, the horizon can be displayed as a blurred gradient.

Example of a blurry horizon: In the envisioned implementation the position of the horizon would move with the viewer.

Key Differences from Cloud Skylight System:
Orientation and Perspective: Unlike the skylight version which is designed for overhead viewing and simulates a vertical perspective of the sky, the window-like system is oriented for horizontal viewing, emulating the perspective of looking out towards a distant horizon.
Visual Content: The primary visual content in this system is the horizon line and its associated elements like color gradients and environmental features, contrasting with the cloud-focused imagery of the skylight system.
Color and Light Dynamics: The window-like system places a greater emphasis on simulating the linear color gradients typical of horizon views, especially during events like sunrises and sunsets. This requires a different approach to color and light manipulation compared to the cloud skylight system.
Interactive Features: Given its orientation and content, the window-like system incorporates unique interactive features and control mechanisms tailored to horizon simulation, such as variable opacity of inkjet dots and linear gradient control.

The following subsections will elaborate on the various technological approaches and configurations employed in the window-like display system to achieve a convincing and interactive simulation of the horizon. These methodologies are specifically adapted to cater to the unique requirements of horizon simulation, differentiating this system from the overhead cloud skylight model in both function and design.

### 1. Multi-Layered Dot Arrangement for Depth Perception

Implementation: Multiple transparent layers, each imprinted with a distinct pattern of colored inkjet dots, are arranged in a stacked formation. The dot density and arrangement are varied across layers to create a vertical parallax effect, enhancing the perception of depth in the horizon view.
Advantages: This method augments the three-dimensional aspect of the simulated horizon, contributing to a more convincing and immersive visual experience.
   2. Synchronization with Environmental Sensing Systems.
Implementation: Integrates with external environmental sensors that monitor real-time conditions such as ambient light intensity and color temperature. The system then adjusts the color and brightness of the inkjet dots in accordance with these external cues.
Advantages: Ensures that the indoor horizon view remains consistent with the external natural environment, thereby enhancing the authenticity of the simulation.

Implementation of Multi-Layered Dot Arrangement for Infinity Focus in Horizon Simulation Using the same approach as described above for displaying clouds at infinity focus, a horizon at infinity focus can also be displayed provided there are no sharp lines at the horizon. When calculating a dot layer for the horizon image, the algorithm will try to solve for a view that has a consistent vertical parallax for all viewpoints. As the viewer moves up and down or gets closer and further from the window the horizon will appear to move with the viewer.

Combining Multiple Thin Sheets into a Single Block

The present disclosure relates to methods and systems for combining multiple thin sheets of acrylic or similar polymer materials into a single, unified block structure. This disclosure finds particular utility in applications requiring precise alignment and optical clarity, such as in display systems, optical devices, and artificial environmental simulations. In embodiments where light is injected into the side of the sheets, combining the sheets into a single block allows for better light transmission into the sheets. Further, combining sheets into a single block can help ensure consistent thermal expansion across all layers when temperature gradients are present. The following detailed description outlines various embodiments and techniques, suitable for achieving a consolidated acrylic block with high precision and structural integrity:

### Embodiment 1: Lamination Technique

### Technical Field

This embodiment pertains to a lamination process involving the use of adhesives or bonding agents to combine multiple acrylic sheets into a cohesive block.

### Methodology

Surface Preparation: Each acrylic sheet is subjected to a thorough cleaning process to remove all contaminants. A non-abrasive cleaning solution may be employed to ensure surface purity without inducing micro-scratches.
Alignment Procedure: The sheets are aligned using precision alignment tools. This may involve laser alignment systems, mechanical jigs, or optical comparators to ensure micron-level accuracy.
Adhesive Application: A bonding agent specifically formulated for acrylic materials, possessing properties such as optical clarity, minimal shrinkage, and high adhesive strength, is uniformly applied. The adhesive may be applied at the edges or over the entire surface area, depending on the design requirements.
Bonding Process: The sheets are pressed together under controlled pressure and temperature conditions to ensure a uniform bond with minimal air entrapment.
Curing Phase: The bonded assembly undergoes a curing process. Parameters such as temperature, humidity, and duration are precisely controlled based on the adhesive properties.
Finishing Operations: Post-curing, the block undergoes finishing operations, including edge polishing and surface smoothing, to achieve the desired optical quality.

### Embodiment 2: Resin Casting Technique

### Technical Field

This embodiment involves encapsulating and bonding thin acrylic sheets within a resin matrix to form a singular, solid block.

### Methodology

Mold Preparation: A mold corresponding to the desired dimensions of the final block is prepared. The mold interior is treated to ensure easy release of the cured block.
Layer Placement and Alignment: Acrylic sheets are sequentially placed within the mold. Alignment is maintained using spacers or mechanical fixtures.
Resin Introduction: A specially formulated resin, compatible with acrylic and characterized by high optical clarity and low shrinkage, is prepared and introduced into the mold, enveloping the acrylic sheets.
Sequential Curing: The resin is allowed to partially cure between the introduction of successive acrylic sheets to ensure proper adhesion and minimize internal stresses.
Full Curing and Demolding: Upon complete resin introduction, the assembly is subjected to a full curing process. Post-curing, the block is removed from the mold.
Finishing Process: The block undergoes a finishing process involving grinding, polishing, and quality inspection to ensure it meets the requisite optical and structural standards.

### Embodiment 3: Fusion Bonding Technique

### Technical Field

This embodiment describes a method of directly bonding acrylic sheets through a fusion process without the use of intermediate adhesives or resins.

### Methodology

Surface Activation: The bonding surfaces of the acrylic sheets are activated through a chemical or plasma treatment to increase their reactivity.
Precision Alignment: The sheets are aligned using high-precision mechanical or optical systems.
Controlled Fusion Process: The sheets are subjected to a controlled environment where temperature and pressure are applied to initiate a fusion bonding process at the molecular level.
Cooling and Solidification: The assembly is gradually cooled under controlled conditions to solidify the bond and minimize internal stresses.
Quality Assurance: The resultant block undergoes rigorous quality checks, including optical coherence tomography (OCT) and stress analysis, to ensure bond integrity and optical clarity.

### Embodiment 4: Solvent Bonding Technique

### Technical Field

This embodiment involves the use of a solvent to dissolve and subsequently fuse the interfaces of the acrylic sheets.

### Methodology

Surface Preparation: The interfaces of the acrylic sheets are cleaned and roughened as needed to enhance the bonding efficiency.
Solvent Application: A solvent compatible with acrylic is applied to the bonding interfaces. The solvent partially dissolves the surfaces, creating a semi-fluid state.
Sheet Fusion: The solvent-treated sheets are brought into contact, allowing the dissolved acrylic to intermingle and fuse upon solvent evaporation.
Bond Strengthening: The assembly is subjected to a controlled environment to facilitate the complete evaporation of the solvent and the strengthening of the bond.
Finishing and Inspection: The final block is finished to the required dimensions and inspected for any solvent-induced optical aberrations or internal defects.

### General Considerations for All Embodiments

Thermal Management: Special attention is given to thermal management during the bonding processes to accommodate and mitigate the effects of thermal expansion and contraction of acrylic
Optical Properties: Ensuring that the chosen bonding method does not adversely affect the optical properties of the acrylic, such as clarity, light transmission, and color fidelity.
Environmental Resistance: The final block is tested for environmental resistance, including UV stability, temperature resilience, and humidity effects.

### Enhanced Method for Layer Creation Using Focused Laser Technology in Artificial Skylight Systems

### Description of the Enhancement:

Objective of Enhancement: The enhancement aims to improve the existing system by embedding multiple layers of dot patterns (e.g. light control members herein) within a single substrate using focused laser technology, thereby simplifying construction, improving alignment precision, and enhancing the overall visual quality of the artificial skylight.

### Technical Implementation:

a. Substrate Material: A transparent material, such as specialized acrylic or crystal, suitable for internal modification by laser technology, is selected as the substrate for the artificial skylight system.
b. Laser Focusing Mechanism: A precision laser system is employed, capable of focusing at various depths within the substrate. The laser modifies the internal structure of the substrate to create dot patterns without altering its surface.
c. Creation of Multi-Layer Dot Patterns: By adjusting the focal depth of the laser, dot patterns are created at different layers within the substrate. This method allows for the simulation of clouds and sky elements at varying perceived depths, enhancing the infinity focus effect.
d. Control and Customization: The system includes a control interface for adjusting the laser parameters, enabling the customization of the dot patterns in terms of size, density, depth, and distribution. Dot parameters can be included in the simulation and optimization parameters to allow for higher quality results to be achieved.

### Embodiment Examples

Example for Layered Structure: A system comprising multiple layers, each layer contributing to the simulation of clouds and sky at optical infinity, including a top layer which can be configured as either transparent or opaque, and additional lower layers with specific dot patterns designed for light manipulation to create the illusion of depth and movement in cloud formations.

Example for Simulation and Validation Techniques: A process utilizing simulation techniques for testing and validating the appearance of the artificial sky from multiple angles, ensuring consistency in the illusion of clouds at optical infinity.

Example for System Adaptability and Variants: A system characterized by its adaptability, capable of switching between configurations with a transparent or opaque top layer, and including variants such as static and dynamic layers, and different illumination methods (e.g., side illumination, self-illumination).

Example for Real-Time Sky Monitoring Integration: A method involving the integration of the system with an outdoor sky monitoring camera to capture real-time sky images, which are then processed to adjust the indoor cloud simulation in synchronization with the outdoor conditions. Example for Multi-Channel LED Integration: A system equipped with a multi-channel LED setup for dynamic sky and cloud color simulation, allowing for the independent control of different color channels to emulate natural sky phenomena like sunsets.

Example for Horizon Simulation in a Window-Like Display System: A method for simulating a dynamic horizon view in a window-like display system, distinct from the cloud skylight system, focusing on the unique visual characteristics of a distant horizon.

Example for Method of Combining Multiple Sheets into a Single Block: A process for combining multiple thin sheets of material into a unified block using techniques such as lamination, resin casting, fusion bonding, or solvent bonding, with applications in precision alignment and optical clarity.

Example for Enhanced Layer Creation Using Focused Laser Technology: An enhanced method for creating multiple layers of dot patterns within a single substrate using focused laser technology, simplifying construction and alignment while enhancing the visual quality of the artificial skylight.

Example for Dot-Patterned Layer Construction: A Example centered on the construction and design of the light-manipulating lower layers, which include etched dot patterns on materials such as acrylic, specifically tailored to create the depth and movement of the cloud display.

Example for Layer Material Composition: A Example for the specific material composition and properties of the layers used in the system, focusing on the use of materials like acrylic or similar substances that are optimized for light manipulation and cloud simulation.

Example for Layer Thickness and Arrangement: A Example addressing the specific thickness and arrangement of the layers, detailing how these factors contribute to the overall effectiveness of the cloud simulation and the perception of depth.

Example for Inter-Layer Optical Interaction: A Example focusing on the interaction between layers, particularly how light is manipulated across different layers to create a cohesive and realistic sky simulation, including the interplay of light and shadow, color gradients, and the simulation of cloud movement.

Example for User-Adjustable Layer Configurations: A Example for a system that allows end-users to adjust or customize the configurations of the layers, enabling them to modify the cloud simulation according to their preferences or specific environmental needs. Adjustments could be provided prior to manufacturing the case of static clouds, or could occur in real-time on the device when dynamic elements are present.

Example for Layer Alignment and Assembly Techniques: A Example detailing the techniques used for aligning and assembling the multiple layers in the system, ensuring precision and maintaining the integrity of the visual simulation.

### More Detailed Write Up:

The proposed method for creating cloud simulations in the artificial skylight system involves a novel approach using multi-layer beat frequency patterns. This method significantly from conventional tomographic or 4D light field displays, primarily in its use of fixed-pitch dots and the generation of specific interference patterns to simulate clouds. Here's a more detailed breakdown of how this might work:

### 1. Layer Composition and Dot Configuration:

Fixed-Pitch Dots: Each layer of the display contains dots that are fixed in their pitch, meaning their spacing does not vary across the layer. This uniformity is crucial for the desired interference pattern.

Material Choice: Transparent materials such as specialized acrylics or similar polymers, chosen for their optical properties, serve as the substrate for these layers.

### 2. Interference Pattern Creation:

Synchronized Layers: When two or more layers with these fixed-pitch dots are synchronized, they create a specific interference pattern. This pattern is made up of repeating geometric shapes like squares and hexagons.

Complex Structures Formation: The overlapping of these simple geometric patterns from multiple layers leads to the formation of more complex, asymmetrical structures that can resemble the bases of clouds.

### 3. Superimposition and Periodicity Concealment:

Pattern Overlay: By carefully superimposing these patterns, the original periodic nature of the geometric shapes can be significantly obscured.

Organic Evolution: Instead of a rigid mathematical reconstruction, allowing the patterns to evolve more randomly can more accurately replicate the dynamic and irregular nature of cloud formations.

### 4. Technical Challenges and Considerations:

Alignment Precision: Ensuring precise alignment of the layers is critical for the interference patterns to form correctly. This might involve advanced manufacturing and assembly techniques. Light Manipulation: The system must be adept at manipulating light to accentuate the depth and movement of the cloud formations. This involves controlling the intensity, color, and distribution of light across the layers.

Computational Modeling: Computational methods, possibly including Fourier analysis, might be used for optimizing the dot patterns and predicting the resulting visual effects.

### Moire and Beat Frequencies

The proposed method for creating cloud simulations in the artificial skylight system using multi-layer beat frequency patterns is closely related to the concepts of Moiré patterns and beat frequencies. Both of these phenomena are integral to understanding how the system can produce realistic, dynamic simulations of clouds. Let's explore how they are interconnected:

### Moiré Patterns:

Definition: Moiré patterns are visual phenomena that occur when two sets of fine patterns, such as lines, grids, or dots, overlap. These patterns typically produce secondary, larger-scale patterns due to interference between the underlying sets.

Layer Overlap: When the fixed-pitch dot layers in the skylight system overlap, they can create Moiré patterns. The fixed pitch and alignment of these layers are crucial for controlling the type and movement of these emergent patterns.

Cloud Simulation: By manipulating the spacing and alignment of the dot patterns on each layer, the system can create Moiré patterns that resemble cloud shapes and movements.

### Beat Frequencies:

Definition: A beat frequency is an interference pattern created when two waves of slightly different frequencies overlap. This results in a new wave pattern whose amplitude varies at a rate equal to the difference in frequencies of the two original waves.

### Application in the System:

Fixed-Pitch Dots as Wave Sources: In this context, the fixed-pitch dots can be thought of as analogous to wave sources. Each layer, with its uniformly spaced dots, is akin to a wave with a specific frequency.

Interference and Beat Patterns: When layers are overlaid, the interaction between their respective ‘frequencies’ (dot patterns) creates an interference pattern similar to a beat frequency in sound waves. This interaction results in the complex, changing visual patterns that simulate cloud movements and structures.

### Integration of Moiré Patterns and Beat Frequencies:

Complex Pattern Formation: The superposition of multiple layers with fixed-pitch dots creates complex visual effects by combining the principles of Moiré patterns and beat frequencies. The resulting patterns are not static but can change and move, simulating the dynamic nature of clouds.

Control and Variability: By adjusting parameters such as the pitch of the dots, the orientation of the layers, and the spacing between them, the system can control the type, scale, and movement of the resulting patterns. This allows for a high degree of customization in cloud simulation. Visual Realism: The key to the system's effectiveness is in its ability to use these optical phenomena to create a visual experience that closely mimics the appearance and behavior of real clouds, adding depth and dynamism to the indoor sky simulation.

### Potential Examples

### 1. Example for Moiré Pattern Generation:

Example: A method for generating Moiré patterns through the overlay of multiple transparent layers, each layer comprising a fixed-pitch dot matrix, wherein the Moiré patterns simulate the appearance and movement of clouds in an artificial sky environment.

### 2. Example for Beat Frequency Simulation:

Example: A system for simulating beat frequency patterns using layered structures, where each layer's dot pattern acts as a wave source, and the interference of these ‘waves’ creates dynamic visual effects representing cloud movements and structures.

### 3. Example for Layer Configuration and Alignment:

Example: A method for aligning multiple layers of fixed-pitch dot matrices in a manner that facilitates the generation of Moiré and beat frequency patterns, contributing to the realistic simulation of cloud formations and dynamics.

### 4. Example for User-Controlled Pattern Manipulation:

Example: A system that allows user manipulation of Moiré and beat frequency patterns, including the ability to adjust dot pitch, layer orientation, and spacing to customize the cloud simulation.

### 5. Example for Integrated Computational Modeling:

Example: A method involving computational modeling to optimize the design of fixed-pitch dot patterns and layer configurations for the most effective generation of Moiré and beat frequency patterns in cloud simulations.

### 6. Example for Dynamic Visual Effect Generation:

Example: A system for creating dynamic visual effects in an artificial sky environment by exploiting the interaction of layered fixed-pitch dot patterns to produce evolving Moiré and beat frequency patterns.

### 7. Example for Optical Property Optimization:

Example: A method for optimizing the optical properties of each layer, including material choice, transparency, and dot pitch, to enhance the formation and visibility of Moiré and beat frequency patterns in cloud simulation.

### 8. Example for Real-Time Pattern Adaptation:

Example: A system capable of real-time adaptation of Moiré and beat frequency patterns in response to external stimuli or user input, enabling dynamic changes in the simulated cloud environment.

### 9. Example for Environmental Integration:

Example: A method for integrating the artificial skylight system with environmental sensors to adapt the Moiré and beat frequency patterns based on real-time environmental conditions, such as light intensity and color temperature.

### 10. Example for Multi-Dimensional Simulation:

Example: A system for simulating multi-dimensional cloud formations using layered Moiré and beat frequency patterns, creating a depth effect and enhancing the perception of a three-dimensional sky.

### Additional Disclosures:

Approach can potentially be used to display any content that is “blurry”. A few examples include:
   Defocused light shining through leaves on a tree.

The approach could be used to create “bokeh” effects where we modify the light distribution of shadows on the surface a display such that light appears to have directionality and come from a distant source rather than flat lambertian distribution.

Using a layer of dot patterns, it is possible to create a surface that acts like a privacy film but allows a view of the background at selective angles.

View of distant buildings or mountains on a very hazy day

By combining the tomographic approach (which can represent in-focus near objects using a stacked layer of dots) with infinite blurry objects, there is an option to show both objects close to the surface that have sharp focus with distant objects having a strong blur.

### Examples

The appearance of water droplets on the surface of the display is sharp, but the distant horizon scene can be blurry; Aurora Borealis.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

LIST OF REFERENCES

2 System
4 Device(s)
6 Output light
10 Output light generation system
14 Diffuse light generation system
16 Sky light component
18 Waveguide
82 Interior face
84 Exterior face
86 Side face
20 Light source
28 Collimated light generation system
30 Sun light component
32 Light source
34 Collimating system
12 Output aperture
22 Transparent member
36 Interior face
38 Exterior face
40 Side face
24 Frame
42 Interior side face
44 Exterior side face
46 Top face
48 Bottom face
26 Housing
50 Distant object component generation system
54 Light control members
56 Optically transparent substrate
58 Layer
60 First face
62 Second face
64 Light source
8 Electrical circuitry

1. An optical display device arranged to generate in an output aperture a virtual a sky scene which is configured to make a user experience distant depth perception, the device comprising:
an output light generation system for generating output light comprising a three-dimensional arrangement of a plurality of light control members, which are carried by one or more optically transparent substrates, and a light source arrange to project light to and/or from the light control members, and;
an output aperture for output of the output light,
wherein the light control members are configured for manipulation of the output light to create a distant object component with one or more features that appear to an observer gazing into the output aperture to be at an apparent depth ZA beyond a physical depth ZD of the device, with ZA being at least 20×ZD,
and ZA is determined by projecting line of sight vectors V1, V2 from first and second viewing positions P1, P2 through the output aperture to a perceived location of the one or more features, with ZA to represent a distance to a convergence point of these vectors beyond the physical depth ZD of the device.

2. The optical display device of claim 1, wherein:
ZA is measured by gaze vectors from eyes of an observer gazing into the output aperture converging on one of more of said features, and/or;
ZA is measured by vectors of a first camera and spatially separated second camera projecting into the output aperture converging on one of more of said features.

3. The optical display device of claim 1, wherein a depth of the one or more features of the distant object component is characterised by a parallax shift corresponding to the apparent depth ZA when observed from laterally displaced positions.

4. The optical display device of claim 1, configured with one or more of the following arrangements:
the optical display device is configured for mounting to a wall or a ceiling as a virtual skylight or virtual window;
the output aperture has a side length or diameter of greater than 25 cm;
an eye box, over which an entire view of the sky scene can be observed, extends over the entire output aperture.

5. The optical display device of claim 1, wherein the light control members are arranged to create the or each feature of the distance object component with Morie interference patterns.

6. The optical display device of claim 1, wherein the output light generation system generates a background diffuse sky light component, which measured absent the distant object component is uniform to the extent where the intensity and/or colour does not vary by more than 10% or 20% or 30% or 40% for any given circular area on the output aperture of 10 mm diameter over at least 90% of the output aperture.

7. The optical display device of claim 1, wherein:
a plurality of optically transparent substrates are arranged adjacent each other as a stack in a depth direction;
the optically transparent substrates arranged parallel to and to extend over the output aperture, and;
the or each optically transparent substrate(s) comprises at least one layer of light control members.

8. The optical display device of claim 1, wherein the light control members are configured to provide a perception one or more of:
the one or more features of the distant object component having said apparent depth ZA and maintaining a fixed apparent depth ZA as the observer moves over the output aperture;
a diffuse sky light component as one or more of a blue, white, grey coloured sky positioned at a distant distance away from an observer gazing into the output aperture, which may surround the or each feature.

9. The optical display device of claim 1, wherein the light source is arranged to project light to the light control members comprises one or more of:
a transparent light panel, which is downstream of the light control members, and projects light to the light control members in an upstream direction for interaction with the light control members and subsequent downstream projection;
an arrangement of sources that are positioned in alignment with the light control members;
a side lit arrangement in which light is projected parallel to a plane of and into the optically transparent substrate(s);
a panel, which is upstream of the light control members, and projects light to the light control members in a downstream direction, and;
collimated light projected to the light control members.

10. The optical display device of claim 1, wherein the output light generation system comprises a background colour emission system arranged to emit a colour of the distant object component or a diffuse sky light component,
the colour emission system emitting diffuse light having a different colour to the light source,
wherein the colour emission system is arranged as a panel upstream of the light control members.

11. The optical display device of claim 1, wherein the light control members are arranged as one or more of:
aligned in a depth direction to each other;
arranged with a same pitch.
deposited formations, including by printing;
redirecting/decoupling formations of the or each optically transparent substrate, to decouple light projected therethough.

12. The optical display device of claim 1, wherein the light control members are configured for light manipulation by one or more of:
absorption of one or more visible wavebands of incident light, and;
transparency to one or more visible wavebands of incident light, including arranged as dome shaped lenses;
emission of one or more visible wavebands of the output light.

13. The optical display device of claim 1, wherein a band emission and/or intensity of the light control members is controllable including by layer and/or a group of a plurality of light control members.

14. The optical display device of claim 1, wherein the light control members have a length scale of 10 μm-1 mm and/or the layers are separated by 0.1 mm-5 mm.

15. The optical display device of claim 1, wherein there are 2-10 layers of light control members and/or the light control members have distinct arrangements over each layer.

16. The optical display device of claim 1, wherein:
the or each feature of the distant object component is a cloud component that comprises one or more of:
1) a colour which is one or more of: white and grey;
2) non-uniform regions with nebulous patterns, and/or;
the or each feature of the distant object component is a horizon component with a perception of a horizon.

17. The optical display device of claim 1 configured with the diffuse sky light component to provide a stationary reference as a background to the distant object component.

18. The optical display device of claim 1, wherein the light source is adaptive to implement adaptation of the or each feature of the distant object component in terms of one or more of:
intensity; colour; depth perception; position,
wherein the distant object component is adaptive based on real time information, wherein the real time information is one or more of:
information based on weather conditions;
information based on time of day, and;
information based on images of a real-life sky.

19. A method of assembling an optical display device arranged to generate in an output aperture a virtual a sky scene which is configured to make a user experience distant depth perception, the method comprising:
arranging a three-dimensional arrangement of a plurality of light control members, which are carried by one or more optically transparent substrates,
arranging a light source arrange to project light to and/or from the light control members,
wherein the light control members are configured for manipulation of output light to create a distant object component comprising one or more features that appear to an observer gazing into the output aperture to be at an apparent depth ZA beyond a physical depth ZD of the device, with ZA being at least 20×ZD,
and ZA is determined by projecting line of sight vectors V1, V2 from first and second viewing positions P1, P2 through the output aperture to a perceived location of the one or more features, with ZA to represent a distance to a convergence point of these vectors beyond the physical depth ZD of the device.

20. A method of generating in an output aperture a virtual a sky scene which is configured to make a user experience distant depth perception, the method comprising:
projecting light to/from a three-dimensional arrangement of a plurality of light control members, which are carried by one or more optically transparent substrates,
manipulating output light with the light control members to create a distant object component comprising one or more features that appear to an observer gazing into the output aperture to be at an apparent depth ZA beyond a physical depth ZD of the device, with ZA being at least 20×ZD,
and ZA is determined by projecting line of sight vectors V1, V2 from first and second viewing positions P1, P2 through the output aperture to a perceived location of the one or more features, with ZA to represent a distance to a convergence point of these vectors beyond the physical depth ZD of the device.
